(19) United States
(12) Patent Application Publication
(10) Pub. No.: US 2025/0058847 A1
(43) Pub. Date: Feb. 20, 2025

(54) Foldable Vehicle

(71) Applicant: Pride Mobility Products Corporation, Duryea, PA (US)

(72) Inventors: Michael A. GRANT, Jermyn, PA (US); Terrence Joseph DONNELLY, West Pittston, PA (US); Walter WATKINS, Courtdale, PA (US); James P. MULHERN, Nanticoke, PA (US)

(73) Assignee: Pride Mobility Products Corporation, Duryea, PA (US)

(21) Appl. No.: 18/826,625

(22) Filed: Sep. 6, 2024

Related U.S. Application Data
(63) Continuation of application No. PCT/US2023/063973, filed on Mar. 8, 2023.
(60) Provisional application No. 63/317,897, filed on Mar. 8, 2022.

(51) Int. Cl. B62K 15/00; B62K 5/02

(52) U.S. Cl. CPC B62K 15/008; B62K 5/02

(57) ABSTRACT

A vehicle may include a frame having a first portion, a second portion, and a tiller. The first portion may be coupled to a front wheel and to the tiller. The second portion may be coupled to a rear wheel and detachably coupled to the first portion. A method of transitioning the vehicle between a folded configuration and an unfolded configuration may include rotating the first portion of the frame relative to the second portion of the frame between the folded configuration and unfolded configuration to cause the first portion of the frame to lock to the second portion of the frame.

### CROSS-REFERENCE TO RELATED APPLICATIONS

This application claims the benefit of U.S. Provisional Patent Application No. 63/317,897 filed Mar. 8, 2022 entitled “Foldable Vehicle,” which is incorporated by reference herein in its entirety.

### FIELD OF THE INVENTION

The present invention generally relates to a mobility vehicle and, more particularly, to a scooter moveable between a folded configuration and an unfolded configuration.

### BACKGROUND OF THE INVENTION

Mobility vehicles are an important means of transportation for a significant portion of society and provide a degree of independence for those they assist. However, this degree of independence can be limited if the user cannot bring the mobility vehicle on a travel experience due to size or shape of the mobility vehicle. Accordingly, there is a need for a mobility vehicle that can be compactly stowed during travel, for example in an overhead compartment of a plane or under a bed on a cruise ship.

Features in accordance with the embodiments described herein include a foldable vehicle capable of being conveniently folded for towing or stowing and unfolded for use. Some users may find a folded mobility vehicle difficult to manipulate due to its size and/or shape. For those users, separating the vehicle into manageable sizes may be helpful. Some users may also find it helpful to tow the a fully assembled or separate portions of the mobility vehicle. For users with limited dexterity, folding, detaching and reattaching the vehicle may also be a challenge. For those users, assembly alignment features are a benefit. Those users may also find that folding functionality that minimizes the complexity and number of lift points is helpful.

### BRIEF SUMMARY OF THE INVENTION

In one embodiment there is a method of transitioning a vehicle between a folded configuration and an unfolded configuration, the vehicle including a frame having a first portion coupled to a front wheel and coupled to a tiller, a second portion coupled to a rear wheel and detachably coupled to the first portion including rotating the first portion of the frame relative to the second portion of the frame between the folded configuration and unfolded configuration to cause the first portion of the frame to lock to the second portion of the frame.

In some embodiments, the vehicle includes a lock moveable from an unlocked state to a locked state, and the rotating step causes one of the first portion and the second portion to move the lock from the unlocked state to the locked state. In some embodiments, one of the first portion and the second portion moves the lock from the unlocked state to the locked state. In some embodiments, the lock is manually moveable from the unlocked state to the locked state when the vehicle is in the folded configuration. In some embodiments, transitioning the lock from the unlocked state to the locked state includes rotating a portion of the lock relative to at least one of the first portion and the second portion.

In some embodiments, the method further includes transitioning the vehicle from the unfolded configuration to the folded configuration, moving the lock from the locked state to the unlocked state, and detaching the first portion from the second portion. In some embodiments, the unlocked state, the first portion is not detachable from second portion if the first portion of the frame and the second portion of the frame are hinged to form an acute angle of at least about 5 degrees, at least about 10 degrees, at least about 5 degrees to about 10 degrees, or at least about 10 degrees to about 15 degrees. In some embodiments, the lock comprises a lever and moving the lock from the locked state to the unlocked state includes manually pivoting the lever relative to at least one of the first portion and the second portion.

In some embodiments, the vehicle includes a hinge comprising a knuckle coupled to one of the first portion and the second portion and a hub bolt detachably received by the knuckle, the rotating including rotating the first portion relative to the second portion about the hinge. In some embodiments, the hub bolt is rotationally fixed relative to the lever, where manually rotating the lever includes rotating the hub bolt relative to the knuckle, and the hub bolt is removably received by the knuckle and the knuckle includes a strike surface configured to block removal of the hub bolt from the knuckle when the first portion of the frame and the second portion of the frame are hinged to form the acute.

In some embodiments, the tiller includes a tiller clutch configured to at least temporarily fix the tiller relative to the frame, the method further including disengaging the tiller clutch such that the tiller is movable relative to the first portion, pivoting the tiller relative to the first portion, and reengaging the tiller clutch such that the tiller is rotationally fixed relative to the first portion. In some embodiments, the method further includes transitioning the vehicle from the unfolded configuration toward the folded configuration by rotating the tiller relative to a ground surface while the tiller clutch is engaged such that the first portion of the frame rotates about a frame rotation axis thereby causing an end of the first portion to be raised vertically.

In some embodiments, the method further includes transitioning the vehicle from the unfolded configuration toward the folded configuration by simultaneously disengaging the tiller clutch and lifting, relative to the ground surface, a handle that is proximate the hinge and coupled to the second portion while the tiller clutch is disengaged such that the first portion of the frame pivots about the front wheel thereby causing an end of the first portion to be raised vertically. In some embodiments, the method further includes grasping a handhold coupled to the end of the first portion and detaching the first portion from the second portion by displacing the first portion relative to the second portion.

In another embodiment, there is a vehicle including a frame including a first portion coupled to a front wheel and coupled to a tiller, a second portion coupled to a rear wheel and detachably coupled to the first portion, and a hinge having a knuckle rotatable about a hub bolt, the knuckle engageable with the hub bolt to secure the knuckle to the hub bolt. In some embodiments, the knuckle is fixed to one of the first portion or the second portion and the hub bolt is locked to the knuckle when the first portion and the second portion are pivoted about the hinge at an acute angle of at least at least about 5 degrees, at least about 10 degrees, at least about 5 degrees to about 10 degrees, or at least about 10 degrees to about 15 degrees.

In some embodiments, the knuckle is fixed to one of the first portion or the second portion and the hub bolt is fixed to the other of the first portion and the second portion. In some embodiments, the vehicle further includes a lock comprising a manual actuator settable to a locked state and an unlocked state while the vehicle is in at least one of the folded state and the unfolded state, the lock configured to automatically transition from the unlocked state to the locked state in response to the vehicle transitioning between the folded configuration and the unfolded configuration.

In some embodiments, the knuckle defines a receiving area to receive the hub bolt such that the first portion is coupled to the second portion when the hub bolt is received by the knuckle. In some embodiments, the knuckle defines a receiving area to receive the hub bolt such that the first portion is coupled to the second portion when the hub bolt is received by the knuckle, and the hub bolt is prevented from entering or exiting the knuckle when the lock is in the locked state

In some embodiments, the hub bolt includes a longitudinal axis with a first cross-section width at a selected point along the longitudinal axis and a second cross-section width at the selected point along the longitudinal axis, the second cross-section width being larger than the first cross-section width. In some embodiments, the hinge includes a leaf and an open keyway between the knuckle and the leaf, the open keyway having an open keyway dimension larger than the first cross-section width of the hub bolt and smaller than the second cross-section width of the hub bolt such that the hub bolt can move into and out of the knuckle when the first portion of the hub bolt is aligned to pass through the open keyway and the knuckle prevents the hub bolt from entering or leaving the receiving area when the second portion of the hub bolt is aligned to pass through the open keyway.

In some embodiments, the vehicle further includes a lock including a lever configured to rotate the hub bolt relative to the knuckle such that the first portion of the hub bolt is oriented to allow the first portion of the hub to pass the open keyway when the lock is in the unlocked state and the second portion of the hub bolt is oriented to block passage of the hub bolt through the open keyway when the lock is in the locked state. In some embodiments, the lever is manually rotatable. In some embodiments, the lock includes a projection configured to engage a portion of the lever such that the lever is automatically rotated as the vehicle moves between the folded configuration and the unfolded configuration. In some embodiments, the hub bolt is rotationally fixed relative to the lever and is rotatably coupled to the one of the first portion and the second portion of the frame.

In some embodiments, the vehicle is transitionable from the unfolded configuration to the folded configuration while the lock is in the locked state and the lock transitions from the unlocked state to the locked state as the vehicle transitions from the folded configuration to the unfolded configuration. In some embodiments, the first portion is rotatable relative to the second portion when the lock is in the locked state.

In some embodiments, the first portion is rotatable relative to the second portion about the hub bolt. In some embodiments, the second portion is detachable from the first portion when the vehicle is in the folded configuration. In some embodiments, the hub bolt is detachable from the knuckle when the first portion and the second portion are pivoted about the hinge at an acute angle of at least at least about 5 degrees, at least about 10 degrees, at least about 5 degrees to about 10 degrees, or at least about 10 degrees to about 15 degrees.

In some embodiments, the tiller is moveable relative to the frame. In some embodiments, the tiller is pivotably coupled to the first portion of the frame such that the tiller pivots relative to the first portion as the vehicle transitions between the folded configuration and unfolded configuration.

In some embodiments, the vehicle further includes a tiller clutch configured to prevent movement of the tiller relative to the first portion. In some embodiments, the tiller clutch includes a disk fixed to one of the tiller and the first portion, a shoe coupled to the other of the tiller and the first portion, the shoe configured to engage the disk, and an actuator configured to selectively move the shoe into and out of engagement with the disk. In some embodiments, the tiller clutch includes a caliper configured to move the shoe relative to the disk.

In some embodiments, the vehicle is configured to at least partially transition from the unfolded configuration to the folded configuration when a force is applied to the tiller. In some embodiments, the force applied to the tiller is configured to cause the first portion of the frame to rotate about a rotation axis such that an end of the first portion is raised relative to a ground surface. In some embodiments, the vehicle includes a tiller clutch configured to prevent movement of the tiller relative to the first portion having a handhold including an actuator, the actuator configured to disengage the tiller clutch such that the tiller is rotatable relative to the first portion. In some embodiments, the handhold is positioned on the tiller such that a user can actuate the actuator and apply the force to the tiller without releasing the handhold. In some embodiments, the actuator is positioned on the tiller such that a user can simultaneously actuate the actuator and apply the force to the tiller without releasing the handhold.

In some embodiments, the tiller includes a first tiller portion and a second tiller portion telescopically nested with the first tiller portion. In some embodiments, the vehicle further includes a wheel brake configured to slow or prevent rotation of the wheel relative to the frame.

In some embodiments, the vehicle further includes a seat coupled to the frame, the seat being moveable relative to the frame between a raised position and a lowered position. In some embodiments, the seat includes a seat base and a seat back, the seat back being rotatably coupled to the seat base. In some embodiments, the seat back includes a stand configured to i) brace the vehicle in an upright folded free-standing configuration; and ii) brace the second portion of the frame in an upright free-standing configuration when the first portion of the frame is disengaged from the second portion of the frame. In some embodiments, the wheel is spaced from the surface when the vehicle is in folded configuration.

In some embodiments, the second portion is upright when the vehicle is in the folded configuration and recumbent when the vehicle is in the unfolded configuration. In some embodiments, the second portion is configured to remain upright when the first portion is decoupled from the second portion. In some embodiments, each of the first portion and the second portion have a respective longitudinal axis that are substantially aligned in an unfolded configuration and that are approximately parallel in a folded configuration.

In some embodiments, the vehicle includes a vehicle longitudinal axis extending from a front of the vehicle to a rear of the vehicle. In some embodiments, the first portion includes a first portion longitudinal axis parallel to the vehicle longitudinal axis when the vehicle is in the unfolded configuration. In some embodiments, the second portion includes a second portion longitudinal axis parallel to the vehicle longitudinal axis when the vehicle is in the unfolded configuration. In some embodiments, the first portion longitudinal axis and the second portion longitudinal axis are laid off relative to a plane perpendicular to a ground surface when the vehicle is in the folded free-standing configuration. In some embodiments, the first portion longitudinal axis and the second portion longitudinal axis are generally parallel when the vehicle is in the unfolded configuration.

In some embodiments, the vehicle includes an unfolded operational cross sectional rectangular area and fully folded cross sectional rectangular area that is approximately ⅓ the size of the unfolded operational cross sectional rectangular area. In some embodiments, the vehicle includes an unfolded operational cross sectional rectangular area and fully folded cross sectional rectangular area that is approximately ⅓ to ¼ the size of the unfolded operational cross sectional rectangular area.

In another embodiment, there is a vehicle including a frame including, a first portion coupled to a front wheel, a second portion coupled to a rear wheel, and a hinge coupled to each of the first portion and the second portion such that the first portion is rotatable relative to the second portion about the hinge to transition the vehicle between a folded configuration and an unfolded configuration, a tiller pivotally coupled to the first portion of the frame, the tiller including a tiller clutch moveable between an engaged configuration and a disengaged configuration, and a handhold coupled to the tiller, the handhold being graspable by a user to pivot the tiller about a tiller pivot axis. In some embodiments, the tiller pivots relative to the frame about the tiller pivot axis when the tiller clutch is in the disengaged configuration and the tiller and first portion of the frame pivot about the tiller pivot axis when the tiller clutch is in the engaged configuration.

In some embodiments, the hinge includes a knuckle rotatable about a hub bolt, the knuckle engageable with the hub bolt to secure the knuckle to the hub bolt wherein the knuckle is fixed to one of the first portion or the second portion and the hub bolt is locked to the knuckle when the vehicle is in the folded configuration. In some embodiments, the tiller includes a tiller actuator configured to transition the tiller clutch between the engaged configuration and the disengaged configuration. In some embodiments, the wherein the tiller actuator is positioned on the tiller such that a user can actuate the actuator and apply the force to the tiller without releasing the handle.

In another embodiment, there is a method of transitioning a vehicle between a folded configuration and an unfolded configuration, the vehicle including a frame having a first portion coupled to a front wheel, a second portion coupled to a rear wheel and detachably coupled to the first portion, and a tiller coupled to the first portion including a tiller clutch configured to at least temporarily fix the tiller relative to the frame. In some embodiment, the method further includes rotating the first portion of the frame relative to the second portion of the frame between the folded configuration and unfolded configuration to cause the first portion of the frame to lock to the second portion of the frame, disengaging the tiller clutch such that the tiller is pivotable relative to the first portion, pivoting the tiller relative to the first portion, reengaging the tiller clutch such that the tiller is rotationally fixed relative to the first portion, and transitioning the vehicle from the unfolded configuration to the folded configuration by rotating the tiller relative to a ground surface while the tiller clutch is engaged such that the first portion of the frame rotates about a frame rotation axis thereby causing an end of the first portion to be raised vertically.

In some embodiments, the tiller includes a handhold and the method includes engaging the handhold with a user's hand. In some embodiments, the disengaging the tiller clutch step and the pivoting the tiller step are both performed without removing the user's hand from the handhold.

### BRIEF DESCRIPTION OF THE SEVERAL VIEWS OF THE DRAWINGS

The foregoing summary, as well as the following detailed description of embodiments of the vehicle, will be better understood when read in conjunction with the appended drawings of an exemplary embodiment. It should be understood, however, that the invention is not limited to the precise arrangements and instrumentalities shown. For example, although not expressly stated herein, features of one or more various disclosed embodiments may be incorporated into other of the disclosed embodiments.

In the drawings:

FIG. 1 is a perspective view of a vehicle in accordance with an exemplary embodiment of the present invention;

FIG. 2a is a perspective view of the vehicle of FIG. 1 in a partially folded configuration according to an exemplary embodiment;

FIG. 2b is a perspective view of the vehicle of FIG. 1 in a partially folded configuration according to an exemplary embodiment;

FIG. 3 is an enlarged perspective view of the hinge lock of the vehicle of FIG. 1 in a partially folded configuration according to an exemplary embodiment;

FIG. 4 is a perspective view of a first portion of a frame of the vehicle of FIG. 1 according to an exemplary embodiment;

FIG. 5 is a perspective view of a second portion of a frame of the vehicle of FIG. 1 according to an exemplary embodiment;

FIG. 6a is a perspective sectional view of a hub bolt of the vehicle of FIG. 1 according to an exemplary embodiment;

FIG. 6b is a perspective sectional view of a hub bolt of the vehicle of FIG. 1 according to an exemplary embodiment;

FIG. 6c is an enlarged perspective sectional view of a hub bolt of the vehicle of FIG. 1 according to an exemplary embodiment;

FIG. 7a is an isolated perspective view of parts of a lock of the vehicle of FIG. 1 in an unlocked configuration according to an exemplary embodiment;

FIG. 7b is an isolated perspective view of parts of a lock of the vehicle of FIG. 1 in an unlocked configuration according to another exemplary embodiment according to an exemplary embodiment;

FIG. 8 is an isolated perspective view of parts of the lock of the vehicle of FIG. 1 in a locked configuration according to an exemplary embodiment;

FIG. 9a is an isolated perspective view of parts of the lock of the vehicle of FIG. 1 as the vehicle transitions between the folded and unfolded configuration according to an exemplary embodiment;

FIG. 9b is an isolated perspective view of parts of the lock of the vehicle of FIG. 1 as the vehicle transitions between the folded and unfolded configuration according to an exemplary embodiment;

FIG. 9c is an isolated perspective view of parts of the lock of the vehicle of FIG. 1 as the vehicle transitions between the folded and unfolded configuration according to an exemplary embodiment;

FIG. 9d is an isolated perspective view of parts of the lock of the vehicle of FIG. 1 in an unfolded configuration according to an exemplary embodiment;

FIG. 10 is an isolated perspective view of parts of the hinge lock of the vehicle of FIG. 1 in the unfolded configuration according to an exemplary embodiment;

FIG. 11 is an isolated perspective view of the front wheel assembly of the vehicle of FIG. 1 according to an exemplary embodiment.

FIGS. 12a and 12b are exploded views of a wheel clutch of the vehicle of FIG. 1 according to an exemplary embodiment;

FIG. 13a is a close-up view of a steering mechanism of the vehicle of FIG. 1 according to an exemplary embodiment;

FIG. 13b is a close-up view of the Handhold and clutch lever of the vehicle of FIG. 1 according to an exemplary embodiment;

FIG. 14 is a side elevational view of the vehicle of FIG. 1 in a folded free-standing configuration;

FIG. 15 is a side elevational view of the vehicle of FIG. 1 in a folded configuration according to an exemplary embodiment;

FIGS. 16a and 16b are front elevational views of the vehicle of FIG. 1 in folded configurations according to exemplary embodiments;

FIG. 16c is a side view of the vehicle of FIG. 1 in a folded configuration according to an exemplary embodiment;

FIG. 16d is a top view of the vehicle of FIG. 1 in a folded configuration according to an exemplary embodiment.

FIG. 17 is a front view of the vehicle of FIG. 1 in an unfolded configuration according to an exemplary embodiment;

FIG. 18 is a rear view of the vehicle of FIG. 1 in an unfolded configuration according to an exemplary embodiment;

FIG. 19 is a side view of the vehicle of FIG. 1 in an unfolded configuration according to an exemplary embodiment;

FIG. 20 is a top view of the vehicle of FIG. 1 in an unfolded configuration according to an exemplary embodiment;

FIG. 21 is a rear perspective view of the vehicle of FIG. 1 in an unfolded configuration according to an exemplary embodiment;

FIG. 22 is a bottom perspective view of a seat of the vehicle of FIG. 1 according to an exemplary embodiment;

FIG. 23a is a side elevational view of the vehicle of FIG. 1 according to an exemplary embodiment;

FIG. 23b is a side elevational view of the vehicle of FIG. 1 according to an exemplary embodiment;

FIG. 23c is a magnified view of a pivot point of the vehicle of FIG. 1 according to an exemplary embodiment;

FIG. 24 is a side view of the vehicle of FIG. 1 in an unfolded configuration according to an exemplary embodiment;

FIG. 25 is a side view of the vehicle of FIG. 1 in a folded configuration according to an exemplary embodiment; and

FIG. 26 is an isolated perspective view of a lift of the vehicle according to an exemplary embodiment.

### DETAILED DESCRIPTION OF THE EXEMPLARY EMBODIMENTS OF THE INVENTION

The present subject matter will now be described more fully hereinafter with reference to the accompanying Figures, in which representative embodiments are shown. The present subject matter can, however, be embodied in different forms and should not be construed as limited to the embodiments set forth herein. Rather, these embodiments are provided to describe and enable one of skill in the art.

Users with limited mobility often utilize a vehicle to move them around. Some users prefer a vehicle that can be folded when not in use to provide a smaller volumetric footprint than when unfolded. It may be desirable to include one or more features that allow a user to move the vehicle between the folded configuration and the unfolded configuration without the need to excessively bend over. It may also be desirable to have a vehicle with detachable portions. Detachable portions may allow a user to lift or move the vehicle one piece at a time to move the vehicle (e.g., into the trunk of an automobile). It may also be desirable for the folded vehicle, or portions of the folded vehicle, to be towable in the folded configuration.

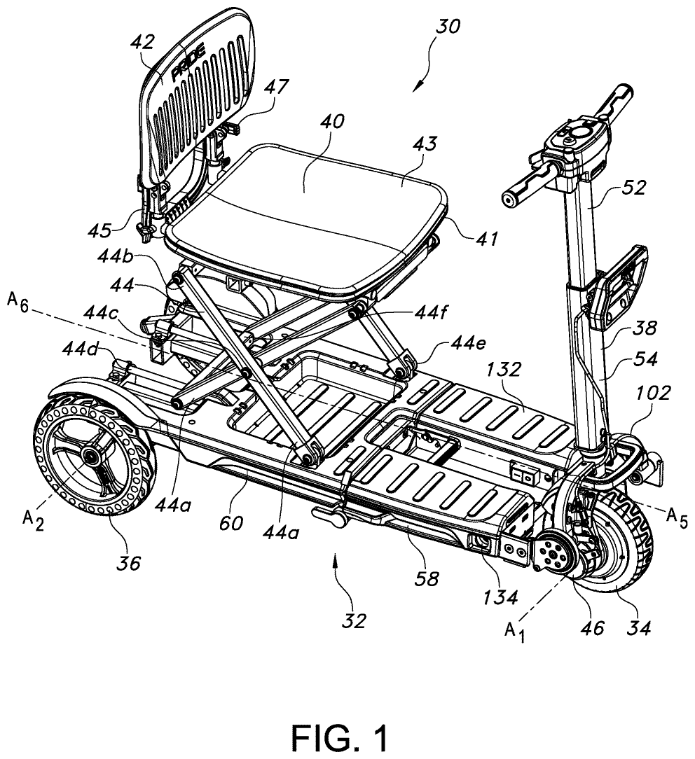

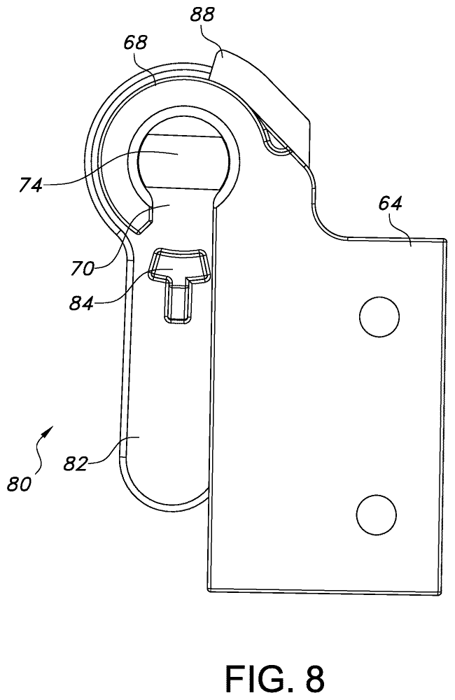

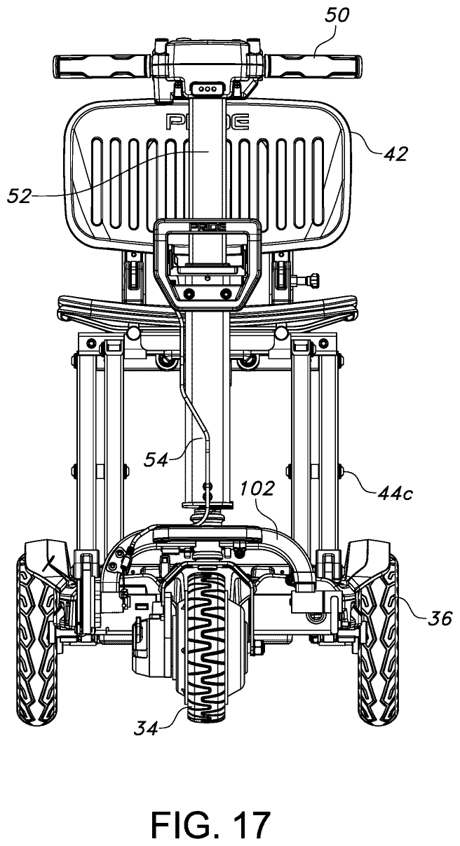

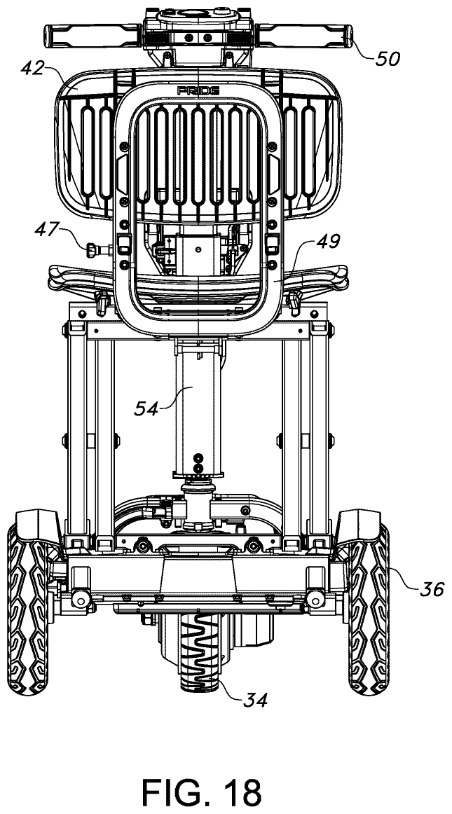

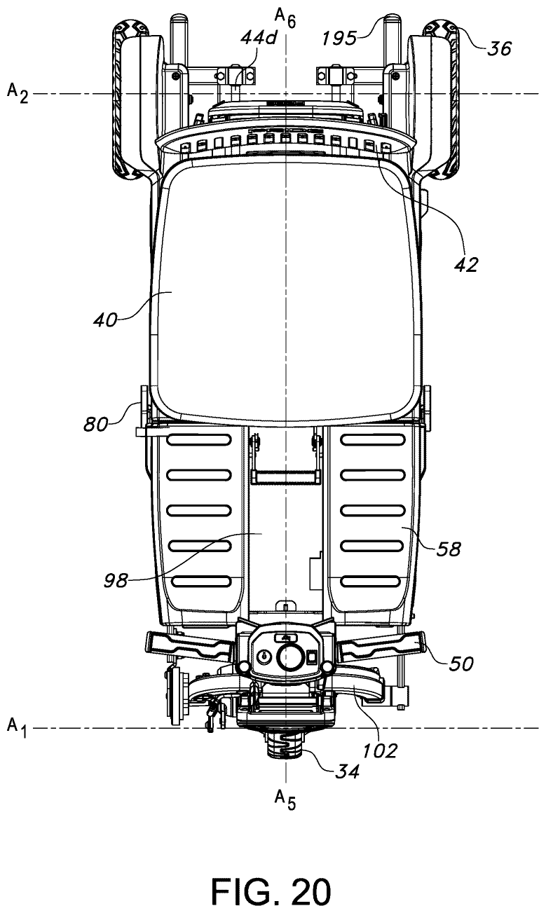

Referring to the drawings in detail, wherein like reference numerals indicate like elements throughout, there is shown in FIGS. 1-25 a vehicle, generally designated 30, in accordance with an exemplary embodiment of the present invention. Vehicle 30 may include a frame 32 or chassis. Frame 32 may include a receiving area for a user to sit, kneel, or lie on. In some embodiments, receiving area includes a seat 40. Vehicle 30 may be a wheeled vehicle such as a scooter. In some embodiments, vehicle 30 is a three-wheeled scooter having a single front drive wheel and two rear non-drive wheels. In some embodiments, vehicle 30 includes a single front drive wheel (e.g., with one wheel or two wheels) in combination with one or more rear wheels. In other embodiments, vehicle 30 may include one or more (e.g., two) rear drive wheels and a single front wheel. In some embodiments, vehicle 30 includes two front wheels (e.g., in close proximity to one another as tandem wheels or spaced apart at or near the spacing of the rear wheels, for example).

In some embodiments, seat 40 is configured to comfortably position an operator of vehicle user on vehicle 30 relative to tiller 38. Seat 40 may also be configured to perform useful functions when vehicle 30 is in a folded configuration. For example, seat 40 may be configured to supported folded vehicle 30 so that vehicle 30 can be left unattended in an upright position. In some embodiments seat 40 includes a low-profile configuration such that when vehicle 30 is in a folded configuration seat 40 is in a close proximity position relative to frame 32. In some embodiments, the low-profile configuration allows vehicle 30 to fit into small overhead compartments or public transportation spaces when vehicle 30 is folded while still fully assembled or with minimal disassembly (e.g., to separate the folded vehicle 30 in 2 pieces).

In some embodiments, seat 40 includes a seat base 41 and a backrest 42. Seat base 41 may be a low-profile seat base 41 configured to support a removeable or non-removeable cushion 43.

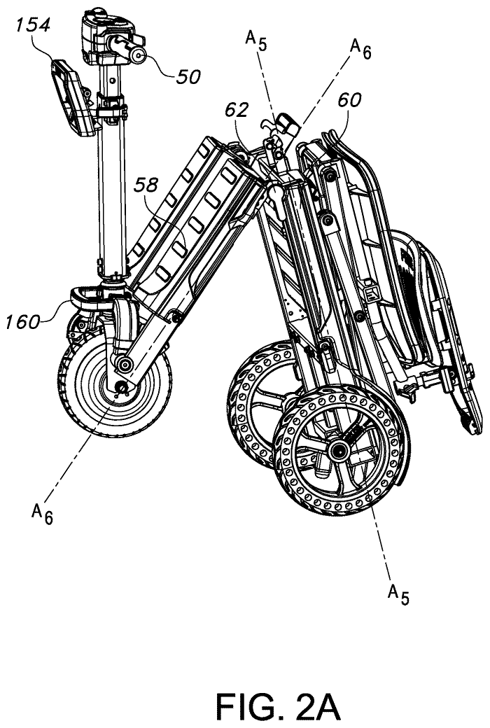

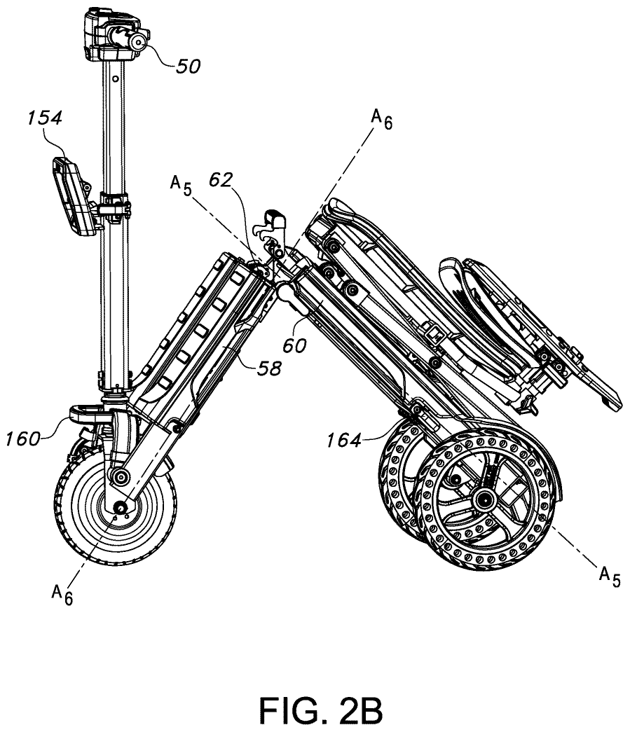

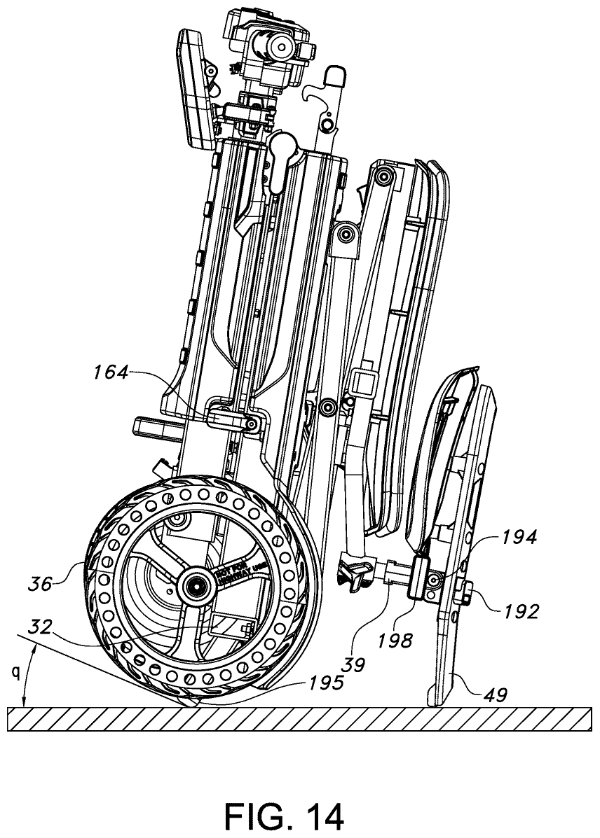

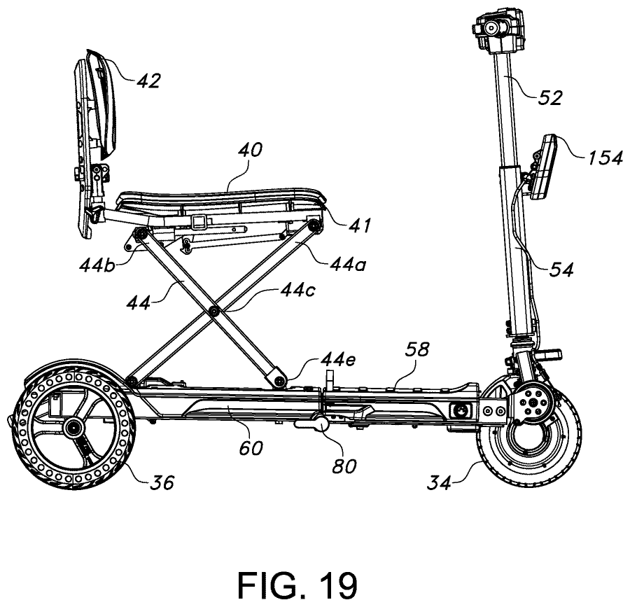

Seat 40 may include a backrest 42 that is moveable between a folded configuration (FIG. 2) and an unfolded configuration (FIG. 1). Backrest 42 may pivot relative to seat base 41. Backrest 42 may be coupled to seat base 41 via support 45. In some embodiments, backrest 42 is removable from seat 40. In some embodiments, backrest 42 is adjustable relative to seat 40 such that it can be temporarily fixed in two or more orientations (e.g., fully folded, fully unfolded, partially folded, selectively angled). In some embodiments, support 45 includes backrest lock 47. Backrest lock 47 may be configured to prevent or allow backrest 42 to pivot relative to seat base 41. In some embodiments, backrest lock 47 includes a locking pin and/or detent with a large enough grip 198 to permit backrest lock 47 to be operated (e.g., locked, unlocked, pivoted) by users with limited hand dexterity. In operation, a user may pull grip 198 to dislodge a locking pin to permit backrest 42 to be easily pivoted. Backrest 42 may include a stand 49 (e.g., a leg, a brace, or leg) configured to contact a surface when vehicle 30 is in a free-standing upright and folded configuration. (e.g., FIG. 14). Stand 49 may be pivotably coupled to seat 40 at a pivot point 194. Backrest lock 47 may be operated to prevent backrest 42 from pivoting either into or out of a folded configuration. In some embodiments, backrest lock 47 secures backrest 42 in a folded configuration to give users comfort that vehicle 30 can stand upright while unattended. In some embodiments, pivot point 194 is positioned above seat base 41 (e.g., FIG. 19). In some embodiments, pivot point 194 is positioned rearward of seat base 41. In some embodiments, pivot point 194 is positioned above and to the rear of seat base 41 (when vehicle 30 is in an unfolded operational configuration as illustrated in FIG. 1). FIG. 14 illustrates pivot point 194 positioned to permit backrest 42 to lie in a close generally parallel configuration relative to seat base 41. Some embodiments of vehicle 30 includes one or more support uprights 39 that are configured to further allow a user to adjust the position of backrest 42 relative to seat base 41 when vehicle 30 is in an operative configuration or a folded configuration. Such adjustments may be made for user comfort (e.g., in the operational configuration) or to reduce the profile of vehicle 30 in a folded configuration (as illustrated, in FIG. 14).

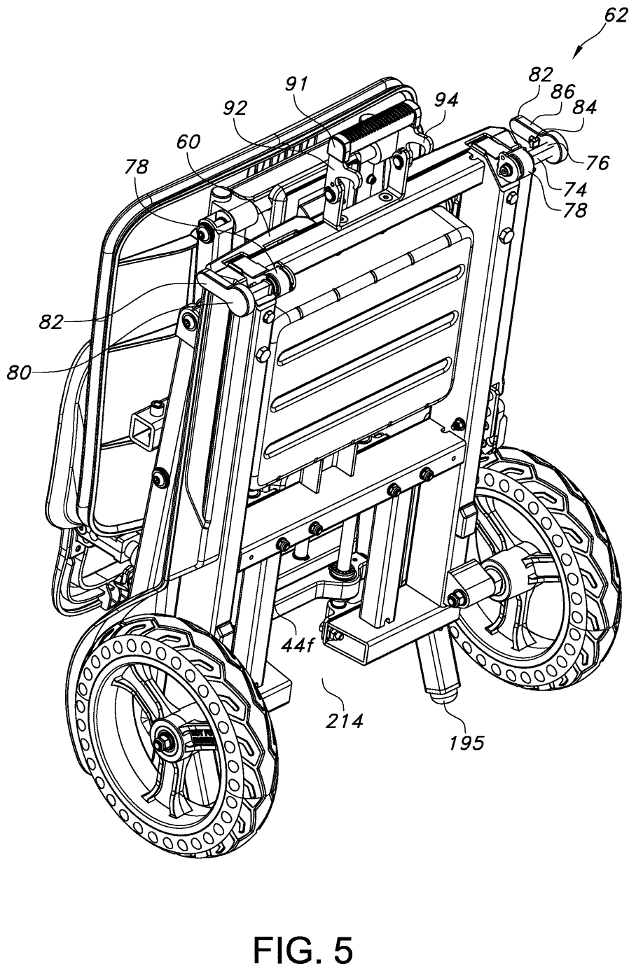

FIG. 14 illustrates one embodiment of vehicle 30 in a free-standing folded position. In some embodiments, vehicle 30 is supported in this position by stand 49. In some embodiments, vehicle 30 includes one or more standing supports 195 (e.g., FIG. 5). In FIG. 14 vehicle 30 is illustrated with two standing supports 195 coupled to and protruding from frame 32. In some embodiments, when vehicle is a free-standing folded position, it is supported (e.g., alone or in combination with other elements of vehicle 30) by stand 49 and standing supports 195. In some embodiments, second frame portion 60 is capable of a freestanding configuration in which it is supported by at least one of stand 49 and standing support(s) 195 when it is not coupled to first frame portion 58 (illustrated, for example, in FIG. 5). In FIG. 14, vehicle 30 is illustrated in a free-standing folded configuration in which stand 49 and standing supports 195 support vehicle 30 in this upright configuration. Wheels 36 are off the ground in this upright configuration and are not contributing to the support of vehicle 30. It will be appreciated from this description and the figures that when second frame portion 60 is detached from first frame portion 58 it is capable of being similarly supported in an upright position as noted above. In one embodiment, standing supports 195 include a high friction end (e.g., a rubber stopper). Standing supports 195 may be configured to allow a user to pivot vehicle 30 about standing supports 195 (e.g., at the high friction end) without having to brace wheels 36 against rolling during the pivot (e.g., where wheels 36 do not engage ground surface over at least a portion of the pivot travel). In one embodiment, a user is able to transition vehicle 30 from a folded free-standing position to a tow position by rocking vehicle 30 toward first frame portion 58 using standing support 195 as a pivot point. Standing supports 195 may also be configured to permit unfolding of vehicle 30 from a free-standing upright configuration such that while a user unfolds vehicle 30, front wheel 34 may be deployed to touch the ground surface while a user rocks vehicle 30 toward first frame portion 58 and simultaneous unfolds vehicle 30. Front wheel 34 may thereby brace vehicle 30 before (or at substantially the same time) rear wheels 36 engage the ground surface to the forward rocking of vehicle 30.

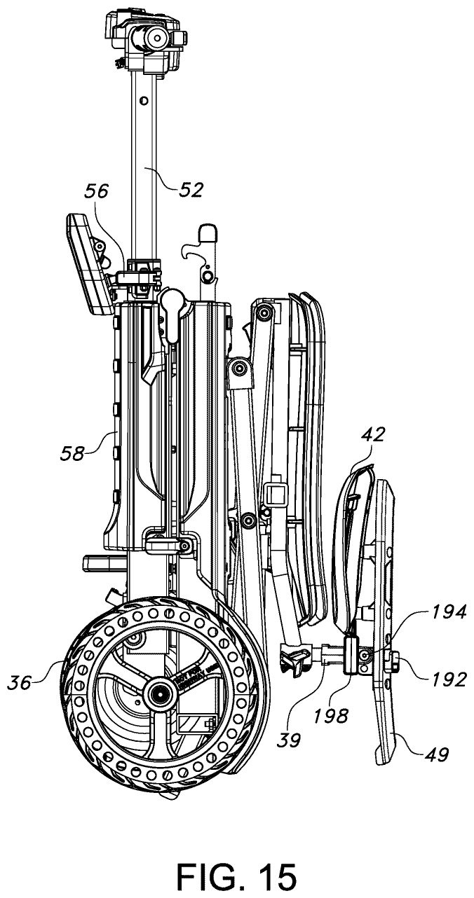

As can be seen in FIG. 15, when vehicle 30 is in a tow configuration with tiller 38 extended (described in more detail below). User can easily pivot vehicle 30 off of supports 195 and stand 49 and onto rear wheels 36. In embodiments where rear wheels 36 are not drive wheels, rear wheels may be configured to always free-wheel or rear wheels may be configured with a user configurable lock to engage or disengage rear wheels 36 into and out of a free-wheel configuration. As noted above, in some embodiments, even if the rear wheel 36 is not blocked, the orientation of standing support 195 may prevent vehicle 30 from undesirable rolling of rear wheels 36 during unfolding.

Seat 40 may further include accessory attachment points 192 (e.g., to permit a handbag, oxygen, umbrella, or other accessories to be conveniently carried). In some embodiments, accessory attachment points are positioned on stand 49 to permit accessories to be conveniently attached even when vehicle 30 is a folded condition and, for example, being towed or rolled by a user.

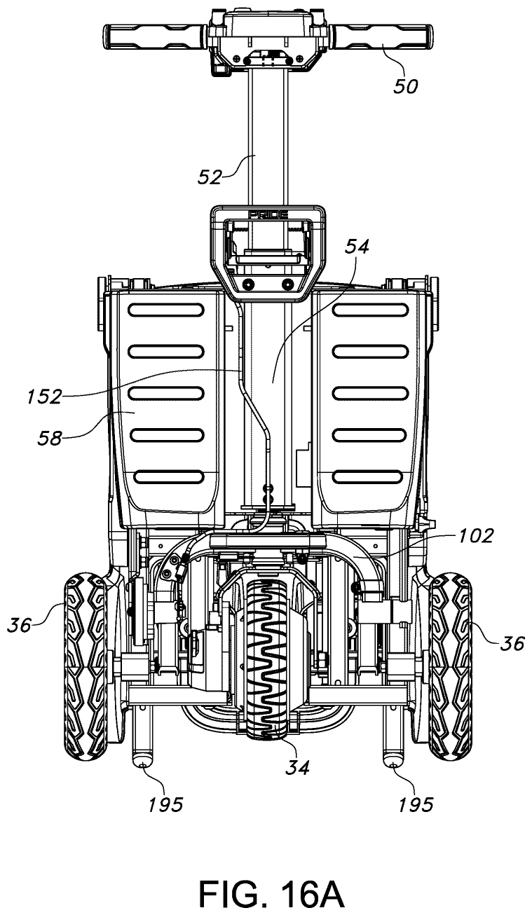

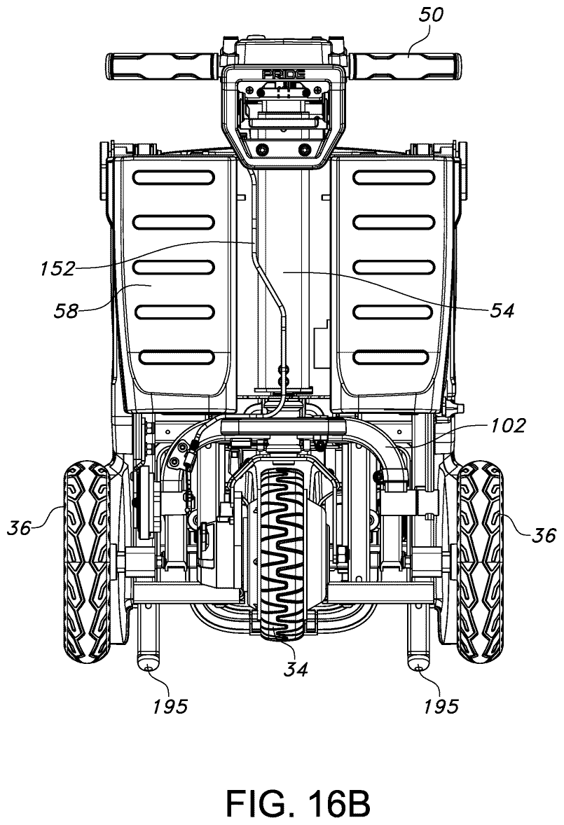

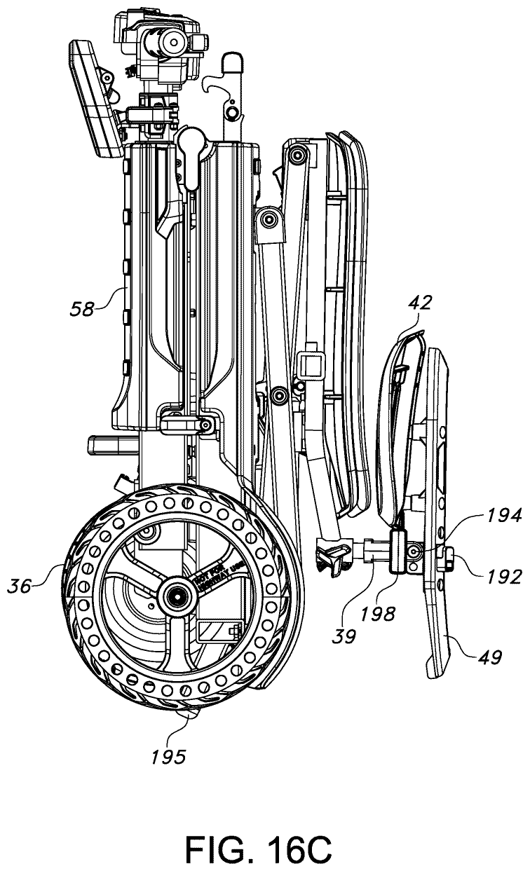

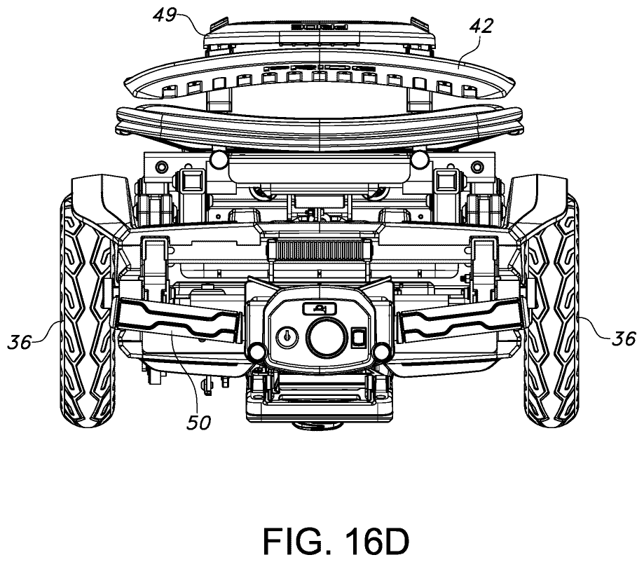

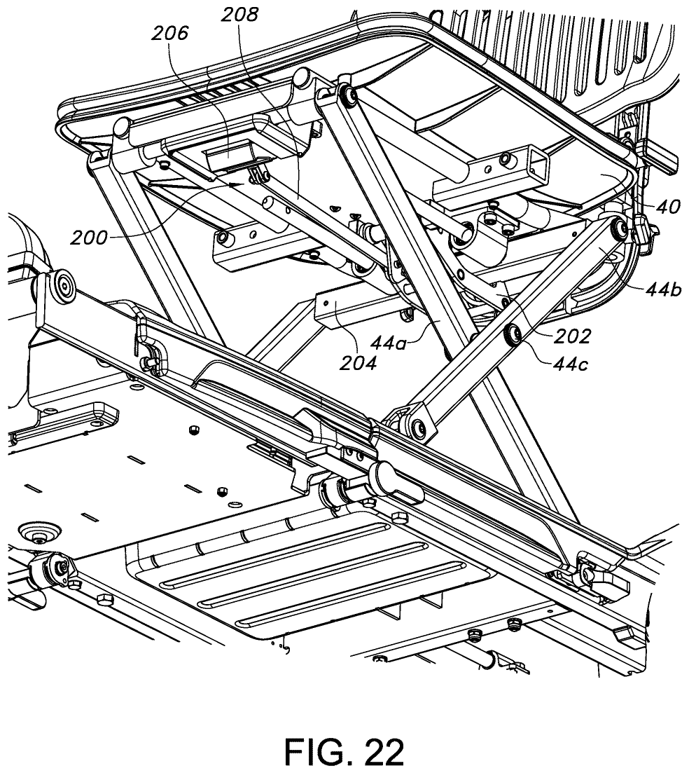

In some embodiments, seat 40 may be coupled to frame 32 by a lift 44 (e.g., FIG. 22). Lift 44 may be configured to allow seat 40 to be positioned at a selected one of a plurality of distances away from frame 32. In some embodiments, lift 44 includes a scissor lift. In some embodiments, lift 44 includes a telescoping lift arm and may be powered by a motor or hydraulic pump (not shown). Lift 44 is preferably configured to provide a low-profile when in a retracted configuration (e.g., FIGS. 16c and 16d). In one embodiment, the low-profile will permit vehicle 30 to be stowed in an overhead compartment or under a bed or other furniture.

In some embodiments, vehicle 30 includes a seat release 200 (FIG. 22) coupled to the seat 40 and the lift 44. In some embodiments, seat release 200 includes a latch 202 configured to fix the position of seat 40 in the desired vertical position relative to frame 32. In one embodiment, vehicle 30 includes two seat positions: fully extended in an operational configuration, and fully lowered in a folded configuration. Seat 40 may lock in a fully extended configuration. Seat 40 may not lock in the fully lowered or folded configuration.

In one embodiment, lift 44 includes a scissor lift with lift supports 44a, 44b coupled together at lift pivot 44c. Vehicle 30 may include two pairs of lift supports 44a, 44b on a right and left side seat 40. Seat release 200 may be configured to engage (directly or indirectly) at least one of lift supports 44a, 44b to securely restrict the pivoting of lift support 44a, 44b at lift pivot 44c. In practice, a user can adjust the height of seat 40 from a position elevated above frame 32 by grasping seat release 200 in one hand and a portion of an opposing portion of seat 40 in the other hand. Seat release 200 may then be engaged as slight upward force is applied to seat 40. In some embodiments, release 200 cannot be disengaged until seat 40 is lifted a predetermined distance (typically a slight distance to permit a latch on release 200 to reach clearance) from an at rest position. Lift 44 and seat release 200 may be configured to cooperation such that the engagement of seat release 200 and the upward movement of seat 40 causes lift supports 44a, 44b to freely pivot about lift pivot 44c. From this freely pivoting configuration, the user may adjust the seat height.

The seat height adjustment includes lowering the seat 40 into close proximity of frame 32 in a folded configuration. In some embodiments, seat release 200 may be eased into an engagement position at any point along the travel length in the freely pivoting configuration to set the height of seat 40 in at least two positions (e.g., fully lowered, fully elevated). In some embodiments, seat 40 may be set at an intermediate point between the upper-most height and lower-most height of seat 40 relative to frame 32. In one embodiment, to lower seat 40, a user would lift seat 40 to put latch 202 into a releasable configuration relative to frame 204. Engagement of release grip 206 in this position, causes latch 202 to clear seat frame 204 via linkage 208 and seat 40 may thereby be lowered proximate to deck 100.

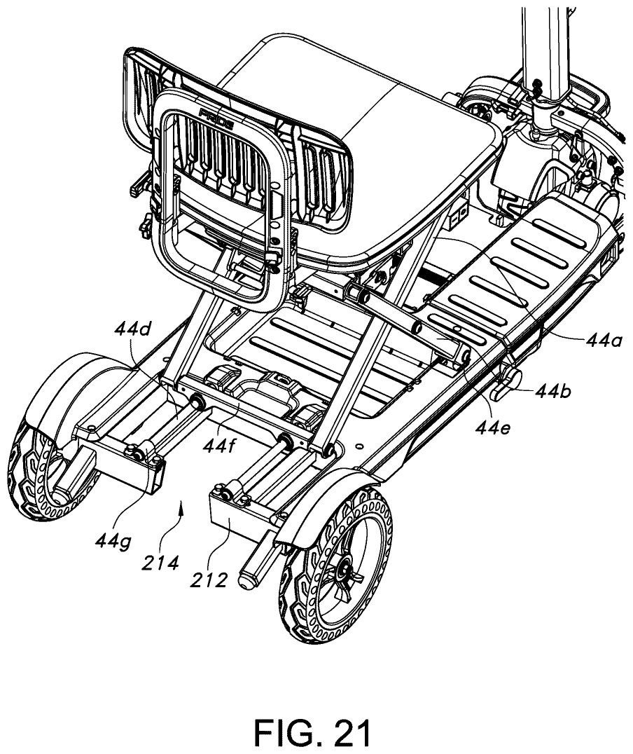

As illustrated in FIG. 1, a first end of lift support 44a may be fixed to frame 32 at a fixed pivot point 44e (FIGS. 19, 21) that allows lift support 44a to pivot about fixed pivot point 44e but prevents lift support 44a from side-to-side or front-to-back movement. The opposing end of lift support 44a may be pivotably coupled to seat 40. Vehicle 30 may be equipped with one or more slide rails 44d (FIGS. 1, 20, 21). Slide rails 44d, may be secured to one or more lift supports 44a, 44b. As illustrated in FIG. 1, lift support 44b is coupled to slide rail 44d in a configuration that permits lift support 44b to slide along slide rail 44d as lift support 44b pivots relative to slide rail 44d. Slide rail 44d and lift support 44b may cooperate to prevent lift support 44b from side-to-side movement (e.g., transverse to the sliding direction along a longitudinal axis of slide rail 44d). In some embodiments, lift support 44a includes (or is coupled to) a sliding stabilizer 44f which is coupled to and is oriented transverse to slide rails 44d. The slide rails 44d may include a stop 44g. Stop 44g may be disposed at or near an end of slide rails 44d. The stop 44g may include an elastomeric material configured to dampen force exerted on rear rail 212 by the sliding stabilizer 44f when, for example, sliding stabilizer 44f is moved to the lowered configuration. The stop 44g may extend around all or part of the slide rail 44d. The stop 44g may be configured to prevent the sliding stabilizer 44f from traveling within a predetermined distance from the end of the slide rail 44d. The stop 44g may be positioned as to not interfere with movement of the lift 44 between the raised and lowered positions. In one such configuration, lift support 44a is pivotably coupled to sliding stabilizer 44f. Sliding stabilizer 44f may provide stiffening support and smooth sliding consistency and smoothness as lift 44 is moved between raised and lowered positions. It will be appreciated that in some embodiments, vehicle 30 includes a lift assembly with fixed front pivot configuration (e.g., as described above) and a rear sliding pivot configuration (e.g., as described above). Lift features may be duplicated on each of the left and right side of vehicle 30. In other embodiments, vehicle 30 may include a fixed rear pivot configuration and sliding forward pivot configuration. As can be seen in FIG. 21, second frame portion 60 may include a rear rail 212. Rear rail 212 may be coupled to slide rails 44d to provided added support. Rear rail 212 may be split (as illustrated in FIG. 21) to allow wheel 34 to pass through the gap 214 in rear rail 212 when vehicle 30 is in a folded configuration (FIG. 14, 16a)

A means (e.g., track or wheel) for moving vehicle 30 may be coupled to frame 32. Front wheel 34 may be coupled to frame 32. Front wheel 34 may rotate about axis A₁ as vehicle 30 moves along a surface (e.g., ground). Although only one front wheel 34 is shown, vehicle 30 may include a second front wheel 34. One or more rear wheels 36 may be coupled to frame 32. Rear wheel 36 may be rotatable about axis A₂ as vehicle moves along a surface. In some embodiments, rear wheel 36 is rotatable about axis A₂ but is otherwise rotationally fixed relative to the frame 32. In some embodiments, front wheel 34 is a caster and the rear wheels 36 are independently rotated by drive motors (not shown) that may include variable drive speeds to steer or assist in steering vehicle 30.

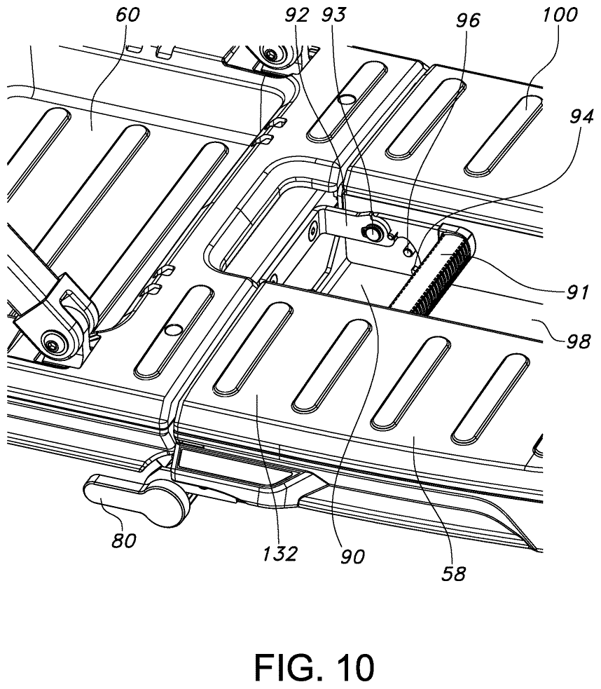

Motor 46 (e.g., electrical motor or combustion motor) may be coupled to front wheel 34 to rotate front wheel such as when front wheel 34 is a drive wheel. Vehicle 30 may include an energy source (e.g., gasoline, diesel, kerosene, voltage source, battery, or photovoltaic cell) that provide energy to motor. Motor 46 may be electrically connected to energy source and a controller (not shown) such that motor rotates front wheel 34 in response to controller sending a movement signal to motor 46. Energy source may be rechargeable. In one embodiment, vehicle 30 includes battery stowage compartments 132 (FIGS. 1, 10) that are accessible to a user when vehicle 30 is any folded or unfolded configuration. For example, stowage compartments 132 may be beneath a quick-release cover that serves as a footrest when vehicle 30 is in use. In one embodiment, a charging station 134 is accessible in any configuration of vehicle 30. Charging station 134 may be configured to receiving a charging fitting to charge vehicle 30 batteries. Charging station 134 may also include ports (e.g., USB ports) to allow a user to charge accessories off of vehicle 30 batteries.

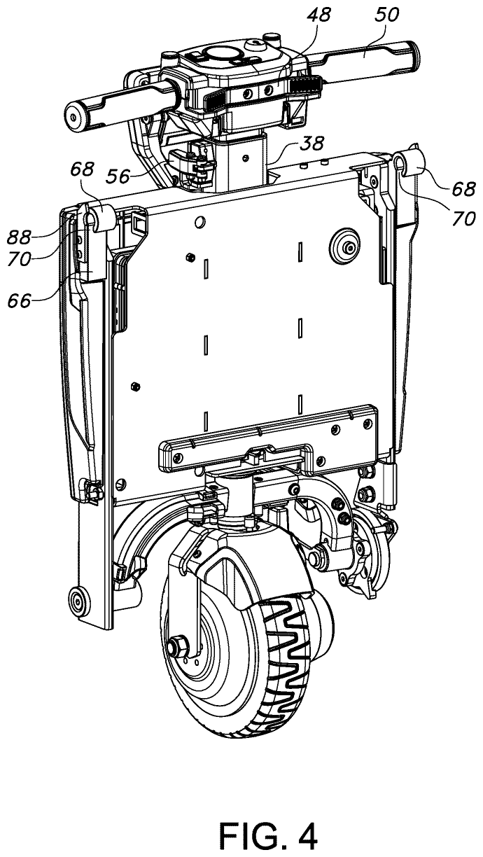

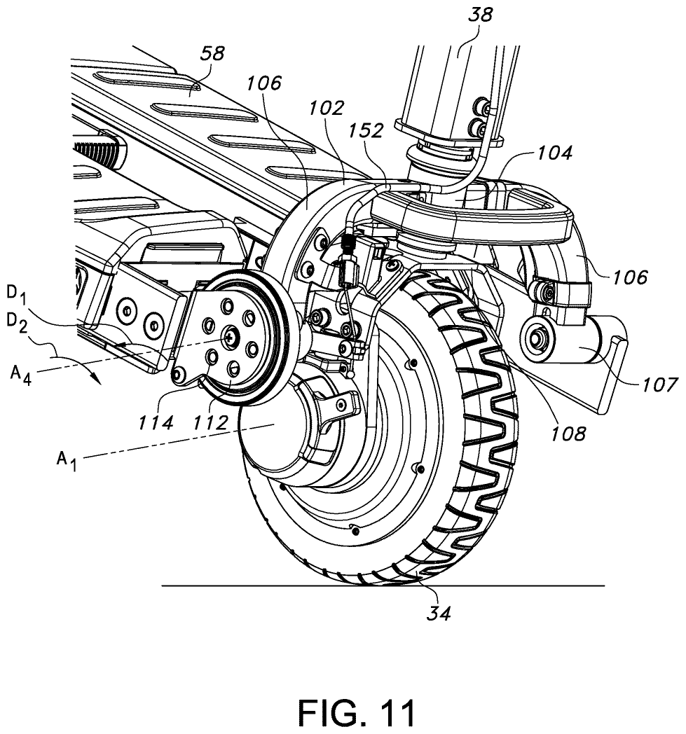

Front wheel 34 may be coupled to a steering device such that front wheel 34 can be turned about a turning axis transverse (e.g., generally perpendicular) to axis A₁ (FIG. 11). In some embodiments, steering device is a tiller 38. In other embodiments, steering device is a steering wheel, touch screen, or sip-n-puff controller. In some embodiments, tiller 38 includes handholds or handles 50 (FIG. 4) that allow a user to rotate tiller 38. In other embodiments, tiller 38 includes a loop or hook that allows a user to rotate or turn tiller 38 without requiring a user's hands.

Referring to FIG. 1, tiller 38 may include a first portion 52 and a second portion 54. Tiller 38 may have an adjustable length. The length of tiller 38 may be telescopically adjustable. In one embodiment, first portion 52 may be telescopically nested within second portion such that first portion 52 is moveable relative to second portion 54. First portion 52 may be fixed relative to the second portion 54 at one of a plurality of selected positions thereby adjusting the length of tiller 38. Tiller 38 may include a lock 56 (FIG. 4) configured to at least temporarily fix the position of the first portion 52 relative to the second portion 54. Lock 56 may include a lever or cammed surface coupled to a pin (interior to features shown). The pin may be spring-loaded and positionable in one or more recess in first portion 52 and second portion 54 to fix the first portion 52 relative to the second portion 54 when lock 56 is in a locked configuration. The spring-loaded portion may cause the lever bias into the locked position. First portion 52 may be moveable relative to second portion 54 when lock 56 is in an unlocked configuration. As described in more detail below, tiller 38 may be pivotably coupled to frame 32. Tiller 38 may be adjusted to be operationally secured at any of a plurality of angles relative to frame 32. Pivoting adjustment of tiller 38 is also useful when folding vehicle 30. The telescoping feature is preferably available to a user when vehicle 30 is in an unfolded operational configuration or a folded configuration.

Referring to FIG. 4, an accelerator 48 may be coupled to tiller 38. Accelerator 48 may be electrically connected to controller such that controller sends a motor signal to motor 46 in response to receiving an acceleration signal from accelerator 48. Accelerator 48 may be a double pole single throw switch. Moving the accelerator 48 to a first position may send a forward movement signal to the controller. Moving the accelerator 48 to a second position may send a rearward movement signal to the controller. Releasing the accelerator 48 may cause a brake system or motor 46 to slow or stop vehicle 30. Rear wheels may include a mechanical brake.

Referring to FIGS. 2-5, frame 32 may include a first frame portion 58 and a second frame portion 60. First frame portion 58 may be rotatable relative to second frame portion 60. First frame portion 58 may be detachable from second frame portion 60. Frame 32 may be moved from an unfolded configuration (FIG. 1) to a folded configuration (FIG. 14) by moving (e.g., rotating) first frame portion 58 relative to second frame portion 60.

First frame portion 58 and second frame portion 60 may each have a respective longitudinal axis that are substantially aligned in the unfolded configuration and that are approximately (or substantially) parallel in the folded configuration. First frame portion 58 may include a first portion longitudinal axis A₆ (FIGS. 1-2) parallel to a vehicle longitudinal axis when vehicle 30 is in the unfolded configuration. Second frame portion 60 may include a second portion longitudinal axis A₅ generally parallel to the vehicle longitudinal axis when vehicle 30 is in the unfolded configuration. First portion longitudinal axis A₆ and second portion longitudinal axis A₅ may be generally perpendicular or at a slight angle to perpendicular to a ground surface when vehicle 30 is in an upright folded configuration (e.g., FIG. 15). First portion longitudinal axis A₆ and second portion longitudinal axis A₅ may be laid off an acute angle to the perpendicular orientation when vehicle 30 is in an upright folded free-standing configuration (e.g., FIG. 14). First portion longitudinal axis A₆ and second portion longitudinal axis A₅ may be generally parallel when the vehicle is in the fully unfolded configuration.

First frame portion 58 and second frame portion 60 may be configured to be separately stowed and or rolled by a user. In one embodiment, each of portion 58 and portion 60 have wheels that are capable of freewheeling when being towed. In some embodiments, one or both of portion 58 and portion 60, can be placed in a wheel lock configuration to prevent or restrict rolling movement. Portion 60 may be oriented upright when vehicle 30 is in a folded configuration and recumbent when vehicle 30 is in the unfolded configuration. Second frame portion 60 may be configured to remain upright and free-standing when the first frame portion 58 is decoupled from the second frame portion 60. Second frame portion 60 may be longer than first frame portion 58 (along the longitudinal axes). Front wheel 34 may be spaced from the ground when vehicle 30 is in the folded configuration and the longitudinal axis of each of first frame portion 58 and second frame portion 60 are generally vertical or set-off from the vertical in, for example, a free-standing upright configuration. A front wheel 34 that is spaced from the ground in the folded or semi-folded configuration may allow a user to grasp handhold 154 (FIG. 2) or handles 50 and roll vehicle 30 around on the rear wheels 36 without the front wheel (which may be a locked drive wheel) engaging with the ground surface.

In one embodiment, each of first frame portion 58 and second frame portion 60 are configured to be separated and towed separate—each with a handle and movable wheels for easy transport. In some embodiment, first frame portion 58 includes a telescoping tiller 38 with handles 50, a handhold 154, and or a lower grip 160. In one embodiment, handhold 154 is fixed to tiller 38 at a position between tiller handles 50 and front wheel 34. As describe below, handhold 154 may also include clutch engagement means and clutch locking means as described herein. In one embodiment, handhold 154 includes a generally arcuate configuration curving and outward and upward from the point at which it couples to tiller 38. In some embodiments, the configuration and dimensions of handhold 154 facilitates raising the tiller from a folded configuration. In some embodiments, lower grip 160 projects forward from yoke 102 (described in more detail below). Together, in some embodiments, handhold 154 and lower grip 160 facilitate lifting of first frame portion 58 especially when it is separated from second frame portion 60 for stowing. In some embodiments, vehicle 30 is configured to be towable in both a folded/assembled configuration such that first frame portion 58 and second frame portion 60 remain connected when towed, and in a separated configuration where first frame portion 58 and second frame portion 60 are towed separately.

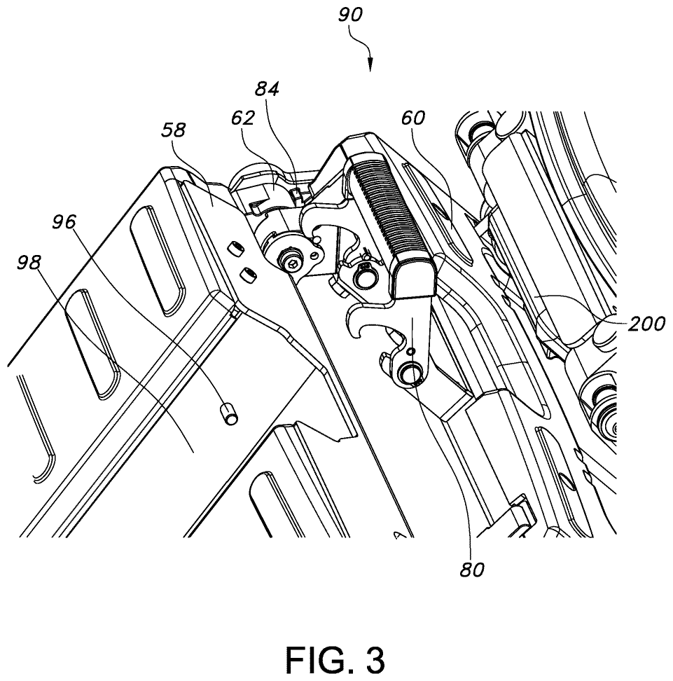

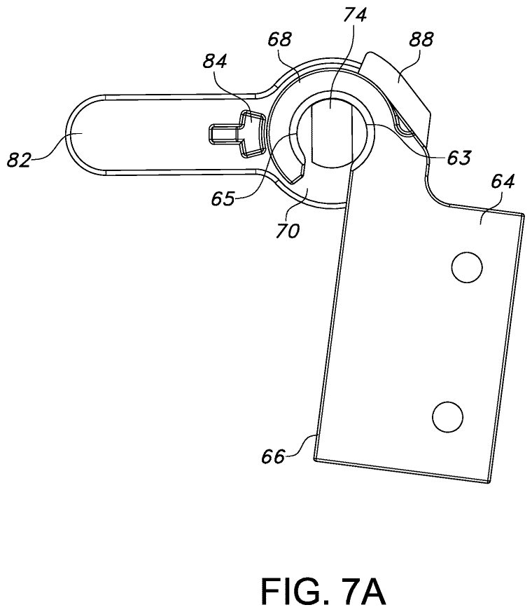

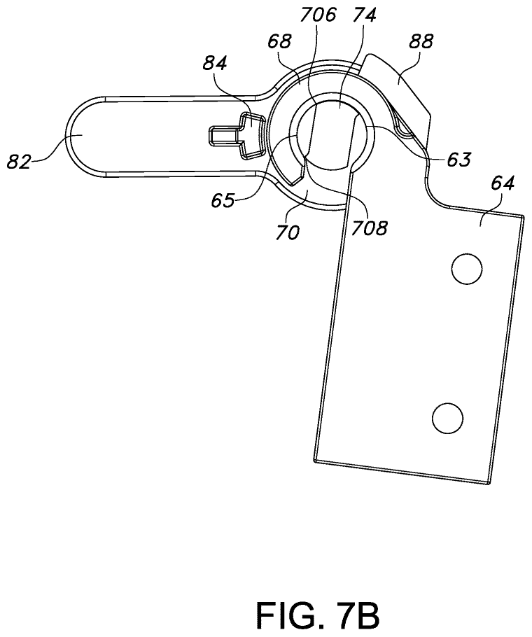

Referring to FIGS. 2-3, first frame portion 58 may be coupled to second frame portion 60 by a lockable hinge 62. First frame portion 58 may be rotatable relative to second frame portion 60 about hinge 62. Hinge 62 may include a leaf 66 and a knuckle 68. Knuckle 68 may include a first end coupled to leaf 66. Knuckle 68 may include a second end spaced from leaf 66, an inner surface and an outer surface. The inner surface of knuckle 68 may define a strike surface 63 (FIG. 7) and race 65 for cooperation with similarly radiused portions of hub bolt 74. The gap between second end of knuckle 68 and leaf 66 defines a keyway (or aperture) 70. Keyway 70 together with the strike surface 63 may be configured to cooperate with hub bolt 74 (FIGS. 5-8). In one embodiment, hub bolt, strike surface 63 and keyway 70 are configured and dimensioned such that hub bolt 74 is directionally insertable into keyway 70 (as explained in greater detail below). In some embodiments, knuckle 68 has an arcuate profile and strike surface 63 defines race 65 which may include a cylindrical receiving area for hub bolt 74. In other embodiments, knuckle 68 (and/or strike surface 63) has a rectangular or polygon shaped profile defining the receiving area for hub bolt 74. A cylindrical knuckle 68 may provide smoother rotation when transitioning frame 32 between the folded and unfolded configurations. Knuckle 68 and leaf 66 may form a knuckle plate 64. Knuckle plate 64 may be coupled to either one of first frame portion 58 and second frame portion 60 and hub bolt 74 can be coupled to the other one of first frame portion 58 and second frame portion 60.

Referring to FIGS. 5-8, hub bolt 74 may be a bolt, shaft, or axle positionable within knuckle 68 such that race 65 is rotatable about hub bolt 74. First frame portion 58 may be locked to second frame portion 60 when hub bolt 74 is within race 65 in a predefined position. In some embodiments, first frame portion 58 is locked to second frame portion 60 only when hub bolt is in a directionally specific orientation relative to keyway 70 and knuckle plate 64.

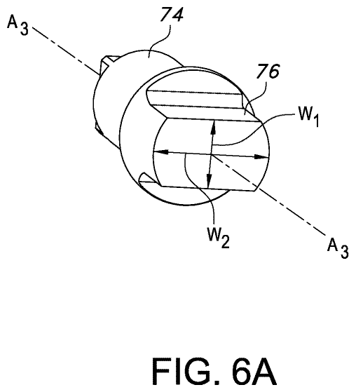

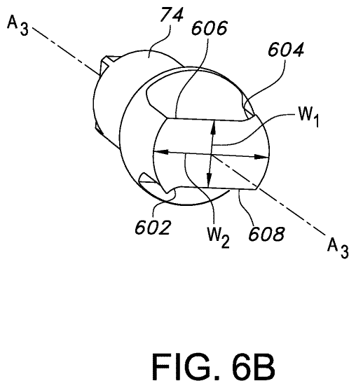

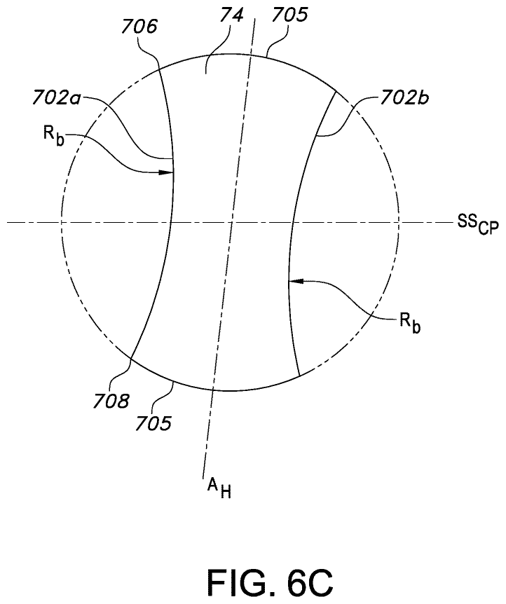

In some embodiments, hub bolt 74 is a D-cut shaft. Hub bolt 74 may include a generally cylindrical shaft with at least one flat side 76 (FIG. 6a). Hub bolt 74 may include a longitudinal axis A₃ with a first cross-section width W₁ at a selected point along the longitudinal axis and a second cross-section width W₂ at the selected point along the longitudinal axis, the second cross-section width W₂ being larger than the first cross-section width W₁.

Hub bolt 74 may be coupled to second frame portion 60 via a bushing or bearing 78 (see, e.g., FIG. 5). Bearing 78 may be a roller bearing, ball bearing, or bearing block. Bearing 78 may include an opening to receive a portion of hub bolt 74. Hub bolt 74 may be coupled to bearing 78 (e.g., via press fit, fastener, weld, or adhesive). Hub bolt 74 may be cantilevered from bearing 78. Hub bolt 74 may be rotatably received by bearing 78 such that hub bolt 74 is rotatable relative to second frame portion 60. In one embodiment, flat side 76 is configured to be substantially parallel with a planar surface deck of either first frame portion 58 or first frame portion 60. In some embodiments, flat side 76 is configurated to be relatively vertical when vehicle 30 is a folded and free-standing configuration. In other embodiments, flat side 76 is configurated to be oriented at a selected angle off of vertical when vehicle 30 is in a folded and free-standing configuration (e.g., FIG. 14). Flat sides 76 may be parallel and define a width of 0.625 inches.

FIGS. 6b and 7b illustrates one embodiment of hub bolt 74. In the embodiment of FIG. 6b, 7b hub bolt 74 includes curved surfaces 602, 604 on opposing edges of hub bolt 74. Curved surfaces 602, 604 in one embodiment are defined by a single radius which meets a tangent of flat surface 606, 608. In one embodiment, curved surfaces 602, 604 are configurated to permit hub bolt 74 to engage strike surface 63 an a more advantageous degree of rotation of hub bolt 74 relative to keyway 70 (compare FIG. 7a to FIG. 7b). In some embodiments, when first frame portion 58 is brought into engagement with second frame portion 60 such as when vehicle 30 is being assembled into a folded configuration, first frame portion 58 is dropped into engagement with second frame portion 60. As first frame portion 58 is dropped into engagement, hub bolt 74 slips through keyway 70. If the engagement occurs, for example, when second frame portion 60 is in a free-standing upright configuration, the weight of first frame portion 58, will cause knuckle plate 64 to rotate slightly relative to second frame portion 60 (a clockwise rotation in the embodiment of FIG. 7b). Curved surfaces 602, 604, in some embodiments, allow for a more predictable and thus easier first engagement of first frame portion 58 and second frame portion 60. And, when the weight of first frame portion causes hub bolt 74 to engage strike surface 63 and knuckle plate 64 to rotate under that weight, the curved surface 602, 604 permit a near locking engagement for hub bolt 74. Thus, a slight further rotation in connection with an unfolding rotation, will engage lock 80. In some embodiments, the surface area of hub bolt 74 that engages strike surface 63 is predefined in a locked state and may positively impact smoothness of rotation.

FIG. 6c illustrates one embodiment of hub bolt 74 in which curved surfaces 705 are configured to engage strike surface 63. Curved surfaces 705 may have a fixed radius of curvature that is substantially the same as the curvature of strike surface 63 (e.g., 0.5 inches). One aspect of hub bolt 6c, includes curved surfaces 702a and 702b. Curved surfaces 702a and 702b may be radial curved surfaces. Preferably curved surfaces 702a and 702b have substantially the same radius of curvature (e.g., 0.33 inches).

In some embodiments, curved surfaces 702a and 702b have a different radius. Radial surface 702a and 702b may extend between curved surfaces 705. In one aspect of hub bolt 74, the center point of curved surface radius Rb for each of curved surfaces 702a and 702b are offset from the equator SS_{CP} of strike surface 63 (e.g., illustrated in FIG. 6c). One benefit of such a configuration is to permit corner 708 of hub bolt 74 to engage strike surface 63 (shown in broken line in FIG. 6c) in locking configuration at an early point of rotation about hinge 62 of first and second frame portions 58, 60 while simultaneously enhancing the ease with which corner 706 may pass keyway 70 when attaching first frame portion 58 to second frame portion 60. Strike surface engaging surfaces 705 in the embodiment of FIG. 6c, have the same combined surfaces areas as the corresponding counterparts of hub bolt 74 in FIGS. 6a and 6b.

In some embodiments, hub bolt 74 includes an orientation axis A_{H} that passes through the cross-sectional center of hub bolt 74 as illustrated in FIG. 6c. In some embodiments, orientation axis A_{H} is generally parallel to second portion longitudinal axis A₅ when hub bolt 74 is an unlocked configuration. In some embodiments, orientation axis A_{H} is non-parallel to second portion longitudinal axis A₅ when hub bolt 74 is an unlocked configuration.

In some embodiments, hub bolt 74 is configured to reach a locked configuration when the relative angle formed between first frame portion 58 and second frame portion 60 is about 10 degrees. In some embodiments, hub bolt 74 is configured to reach a locked configuration when the relative angle formed between first frame portion 58 and second frame portion 60 is about 10 degrees to about 15 degrees. In some embodiments, hub bolt 74 is configured to reach a locked configuration when the relative angle formed between first frame portion 58 and second frame portion 60 is about 5 degrees. In some embodiments, hub bolt 74 is configured to reach a locked configuration when the relative angle formed between first frame portion 58 and second frame portion 60 is about 5 degrees to about 10 degrees.

In some embodiments, hub bolt 74 of FIG. 6c is configured to reach a locked configuration when the relative angle formed between first frame portion 58 and second frame portion 60 is about 5 degrees smaller than the angle for the hub bolt illustrated in FIG. 6a even when the respective keyway 70 may be of the same dimension.

Hub bolt 74 may be moved through keyway 70 and into race 65 when hub bolt 74 is in an unlocked state such that first cross-section width W₁ is aligned to pass through keyway 70 (FIGS. 6-8). Hub bolt 74 may be rotatable relative to knuckle plate 64 when hub bolt 74 is in disposed within race 65 to move hub bolt 74 to a locked state such that second cross-section width W₂ is aligned to pass through keyway 70. Second cross-section width W₂ may be larger than keyway 70 such that knuckle plate 64 prevents hub bolt 74 from exiting when hub bolt 74 is in the locked state. Hub bolt 74 may be locked to knuckle plate 64 in the locked state.

Referring to FIGS. 5, hinge 62 may include a lock 80. Lock 80 may cause rotation of hub bolt 74 relative to second frame portion 60 as vehicle 30 is moved between the folded and unfolded configurations. Lock 80 may prevent hub bolt 74 from rotating (e.g., from the locked state to the unlocked state) relative to second frame portion 60 when vehicle 30 is in an unfolded operational configuration. Lock 80 may be moveable between a locked state and an unlocked state. Lock 80 may automatically transition from the unlocked state to the locked state in response to vehicle 30 transitioning from a folded configuration to an unfolded configuration. Vehicle 30 may, in some embodiments, be transitionable from the unfolded configuration to the folded configuration while lock 80 is in the locked state. Lock 80 may transition from the unlocked state to the locked state as vehicle 30 transitions from a folded configuration to an unfolded configuration. In some embodiments, lock 80 is configured to include one or more of the following features: i) automatically transition from the unlocked state to the locked state in response to vehicle 30 transitioning from a folded configuration to an unfolded configuration; ii) remain in a locked state when vehicle 30 transitions from an unfolded configuration to a folded configuration; and/or iii) transition from an unlocked state to a locked state as vehicle 30 transitions from a folded configuration to an unfolded configuration.

Lock 80 may include a manual actuator or lever 82 settable to a locked state and an unlocked state. Lever 82 may be moveable between the locked state and unlocked state when the vehicle is in the folded configuration. Hub bolt 74 may be prevented from entering or exiting the knuckle when lock 80 is in the locked state. Hub bolt 74 may be fixed to lever 82 such that hub bolt 74 moves (e.g., rotates) in unison with lever 82. In some embodiments, hub bolt 74 and lever 82 are rotationally fixed to each other via a pin or press fit. In other embodiments, lever 82 includes a keyed recess (e.g., a rectangular or hexagonal recess) adapted to receive a similarly shaped portion of hub bolt 74 to rotationally fix hub bolt 74 relative to lever 82. In still other embodiments, lever 82 includes a keyed recess and a pin to rotationally fix hub bolt 74 to lever 82.

Lever 82 may include a protrusion 84 extending from lever body 86 (e.g., toward the interior of vehicle 30 (FIGS. 3, 7-9d). A flange 88 may be coupled to leaf 66 (FIG. 4). Flange 88 may be fixed relative to leaf 66. Flange 88 may engage protrusion 84 and rotate lever 82 to the locked state as vehicle 30 is transitioned from the folded configuration to the unfolded configuration. In some embodiments, flange 88 is detachably coupled to knuckle plate 64 (e.g., via fastener or magnet). In other embodiments, flange 88 is fixed to leaf 66 (e.g., via fastener, adhesive, or weld). In still other embodiments, flange 88 and leaf 66 are a unitary construct. For example, flange 88 could protrude from a surface of leaf 66 toward protrusion 84 such that flange 88 engages protrusion 84 as vehicle 30 is transitioned from the folded configuration to the unfolded configuration.

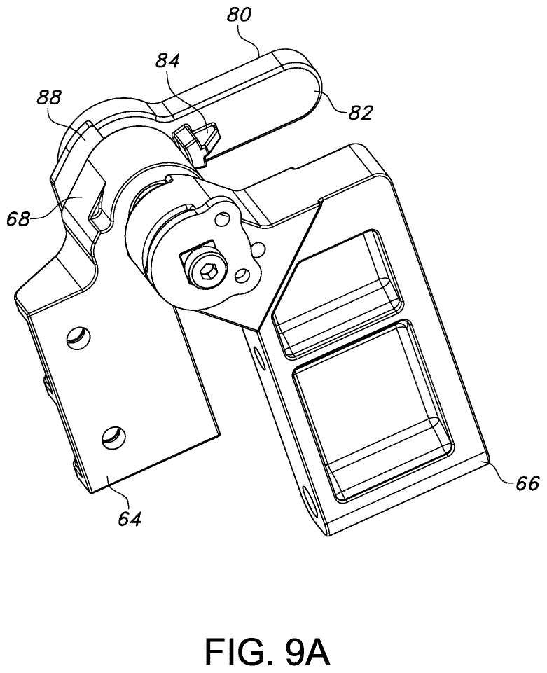

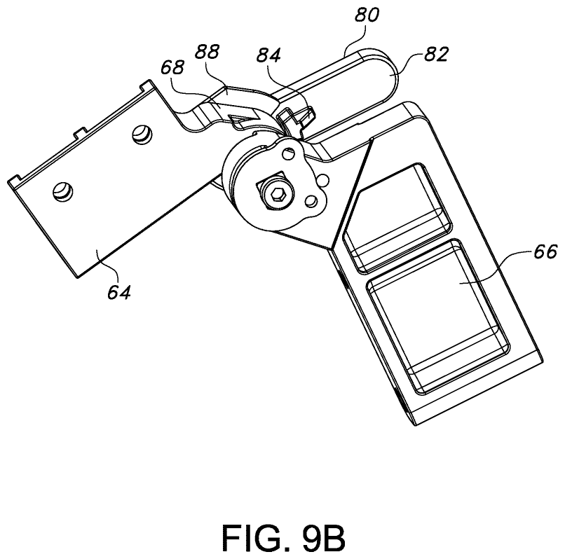

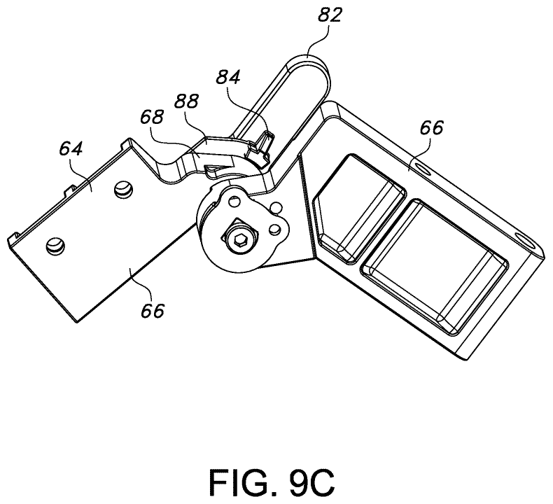

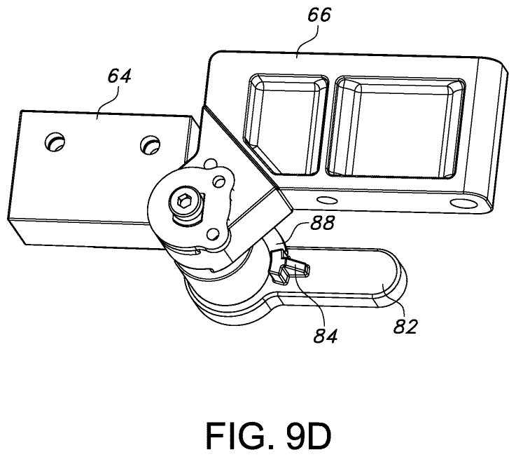

FIGS. 9a-9d illustrate one embodiment of the lock 80 moving the hub bolt 74 from the unlocked state to the locked state as the vehicle 30 moves from a folded configuration to and unfolded configuration. First frame portion 58 and second frame portion 60 are not shown in FIGS. 9a-d for ease of illustration. FIG. 9a illustrates an orientation of lock 80 when vehicle 30 is a folded configuration. Hub bolt 74 may be in the unlocked state during an initial unfolding of vehicle 30 from the unfolded configuration to the folded configuration (FIG. 7). As vehicle 30 is unfolded, leaf 66 (rotating counterclockwise in FIG. 9a) and knuckle plate 64 (moving clockwise in FIG. 9a) rotate relative to each other. As rotation continues, protrusion 84 approaches flange 99 (FIG. 9b). When the relative rotation is to a sufficient degree, an edge of flange 88 moves into engagement with protrusion 84 (FIG. 9c). Flange 88, though its engagement with protrusion 84, causes hub bolt 74 to rotate into the locked configuration as unfolding continues after flange 88 engages protrusion 84 (FIG. 9c). In some embodiments, flange 88 moves hub bolt 74 to the locked state prior to the vehicle being completely unfolded. In other embodiments, hub bolt 74 moves to the locked configuration when vehicle 30 is completely unfolded. Hub bolt 74 or lever 82 may provide audible or tactile feedback to indicate when hub bolt 74 is in the locked configuration. Flange 88 may not engage protrusion 84 when hub bolt 74 is in the locked state before transitioning from the folded configuration to the unfolded configuration. Flange 88 may prevent lever 82 from rotating to the unlocked state when vehicle 30 is in an unfolded configuration. In FIG. 9d, vehicle is in a fully unfolded configuration and flange 88 is preventing counterclockwise rotation of lever 82 and thus movement to an unlocked configuration. In some embodiments, lock 80 is prevented from transitioning from a locked state to an unlocked state when vehicle 30 is in any unfolded operational conditional condition. In some embodiments, lock 80 is prevented from transitioning to a locked configuration unless vehicle 30 is within a certain degree of being in a fully folded configuration.

Lever 82 may be manually moved to transition hub bolt 74 from the locked state to the unlocked state (in some cases in folded condition only). First frame portion 58 may be rotatable relative to second frame portion 60 when lock 80 is in the locked state. Hub bolt 74 may remain in the locked state as vehicle 30 is moved from the unfolded configuration to the folded configuration. Knuckle plate 64 may be disengaged from hub bolt 74 when hub bolt 74 is in the unlocked state by moving hub bolt 74 through keyway 70. Keyway 70 may be oriented such that hub bolt 74 can only be removed from knuckle plate 64 when vehicle 30 is at least partially in the folded configuration. In some embodiments, keyway 70 is oriented such that hub bolt 74 can only be removed from knuckle plate 64 when vehicle 30 is in a fully folded configuration. Hub bolt 74 may be moved through keyway 70 by moving (e.g., lifting or sliding) first frame portion 58 relative to second frame portion 60. For example, a user may grasp a handhold (e.g., handhold 154) coupled to the end of first frame portion 58 and first frame portion 58 from the second frame portion 60 by displacing the first frame portion 58 relative to the second frame portion 60.

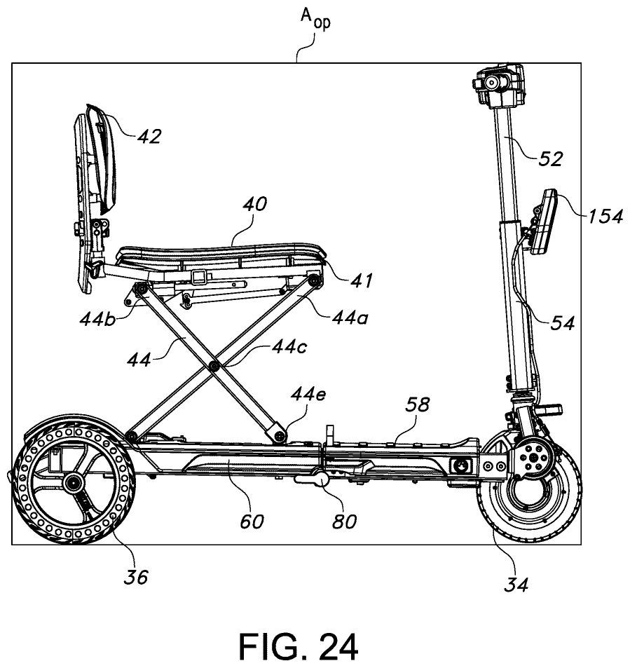

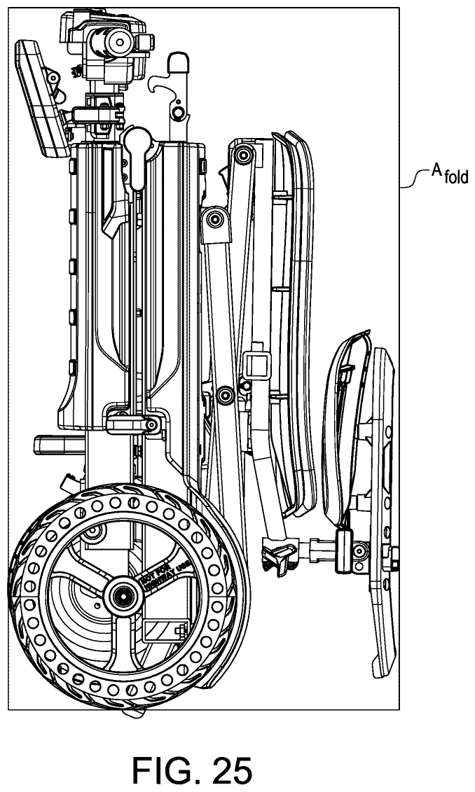

Vehicle 30 may be easily transitioned from a fully operational unfolded configuration (e.g., FIG. 24) to a fully folded configuration (e.g., FIG. 25) by a single user with limited strength and agility and no external tools. In one embodiment, vehicle 30 is large enough in an unfolded operation condition to accommodate a fully grown adult of up to 300 pounds in weight and in a fully folded configuration stow in an airplane overhead compartment. In one embodiment, illustrated in FIG. 24 vehicle 30 may characterized as having an unfolded two dimensional extent of Aₒₚ and a fully folded two-dimensional extent of A_{fold}. In some embodiments, A_{fold} is 30% of Aₒₚ. In some embodiments, A_{fold} is about 25% to about 35% of Aₒₚ. In some embodiments, A_{fold} is 30% of Aₒₚ.

Transitioning vehicle 30 from the unfolded configuration to the folded configuration may include moving or rotating first frame portion 58 relative to second frame portion 60 (e.g., about hinge 62). In one embodiment, this occurs after backrest 42 has been folded down and seat 40 has been lowered to deck 100.

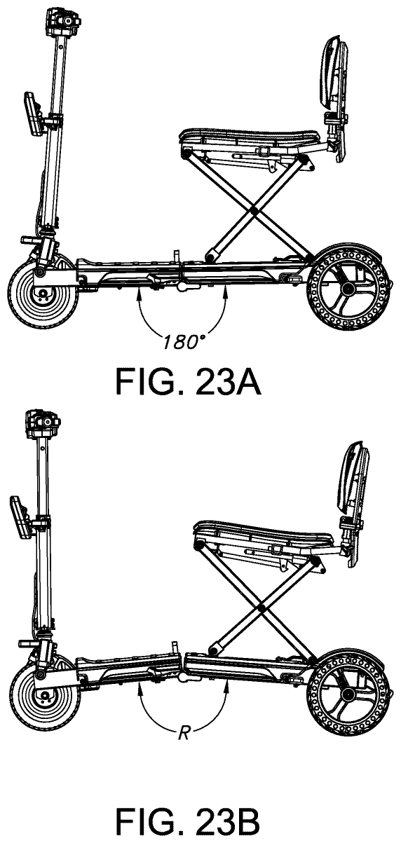

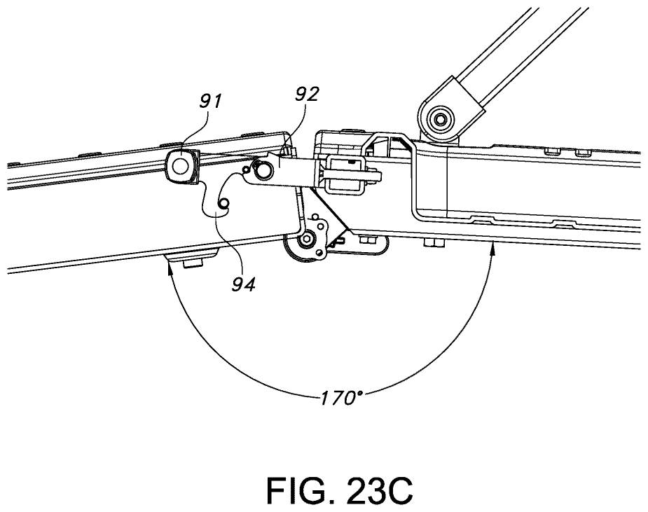

One of first frame portion 58 and second frame portion 60 may include a hinge lock 90 (FIGS. 3, 10, 23c). In a locked configuration, hinge lock 90 restricts relative rotation of first frame portion 58 and second frame portion 60 about hinge 62. In a locked restricted configuration, hinge lock 90 is configured to limit the degree to which first frame portion 58 and second frame portion 60 may pivot relative to one another about hinge 62. In some embodiments, in the locked restricted configuration, first frame portion 58 and second frame portion 60 are permitted to pivot from being in a generally co-planar operational configuration (e.g., FIG. 23a) to being in an operational configuration where their respective longitudinal axes form an acute angle of no more than 5 degrees to 15 degrees, about 170 degrees and/or 170 degrees. In one embodiment, when vehicle 30 travels a curb and hinge lock 90 is in the locked configuration, first frame portion 58 and second frame portion 60 may pivot relative to one another as a result of vehicle 30 being subject to folding forces. In one embodiment, hinge lock 90 is configured to transition without user intervention, from an unlocked state when vehicle 30 is in a folded condition to a locked state when vehicle 30 is an unfolded condition. In one embodiment, lock 90 automatically achieves a locked configuration upon unfolding vehicle 30 on a generally horizontal surface. In some embodiments, lock 90 automatically achieves a locked configuration upon unfolding vehicle 30 so that vehicle 30 is in an operation configuration. That operational configuration may be one in which vehicle 30 is oriented such that it is pointed between a downhill forward movement configuration to an uphill forward movement configuration of no more than 60 degrees of the horizontal.

In one embodiment, lock 90 is configured to permit a pre-determined degree of rotation R (FIG. 23b) between first frame portion 58 and second frame portion 60 when vehicle 30 is in a generally unfolded operational condition (e.g., FIGS. 23a-23c). The degree of rotation R may preferably be about 170 degrees as illustrated in FIG. 23b. Degree of rotation R may be from about 165 degrees to about 175 degrees.

In the locked state, catch 94 may not engage fastener 96, though catch 94 may be positioned to engage fastener 96 and restrict further movement after a selected degree of rotation R (e.g., FIG. 23b). In one embodiment, catch 94 engages fastener 96 to restrict vehicle 30 from folding to a predetermined degree of rotation R.

In an unlocked configuration, hinge lock 90 may be configured to not restrict the folding or pivoting of first frame portion 58 relative to second frame portion 60. In one embodiment, such as in FIGS. 3 and 10, hinge lock 90 includes hinge lock handle 91, receiver 92, axle 93, catch 94, and one or more fasteners 96. One of first frame portion 58 and second frame portion 60 may include a hinge lock handle 91 (FIGS. 3, 10). A user may grasp hinge lock handle 91 to move second frame portion 60 relative to first frame portion 58. In one embodiment, the act of lifting on hinge handle 90 causes handle catch 94 to buy pass fastener 96 as vehicle 30 transitions from an unfolded to a folded configuration.

Hinge lock handle 91 (e.g., FIG. 10) may be coupled to second frame portion 60 via adhesive, weld, or fastener. Hinge lock handle 91 may be coupled to second frame portion 60 via receiver 92. Hinge lock handle 91 may be pivotably coupled to receiver 92 (e.g., via an axle 93) and pivotable relative to second frame portion 60. Receiver 92 may define a channel to allow a user to grasp hinge lock handle 91 without their hand contacting second frame portion 60. Hinge lock handle 91 may include a catch 94. Catch 94 may be configured to receive and/or engage one or more fasteners 96 (e.g., peg, pin, protrusion, or dowel) of first frame portion 58 (FIG. 10). Fasteners 96 may protrude into the pivot path of hinge lock handle 91. It will be appreciated from this disclosure and the figures that hinge lock handle 91 may be coupled to first frame portion 60 and fasteners 96 may be included on second frame portion 60, in some embodiments. Catch 94 may include a sidewall defining an open-ended enclosure to receive fastener 96 (e.g., configured to include a hook).

Each of first frame portion 58, second frame portion 60 and hinge lock 90 may be configured and dimensioned to cooperate in order to 1) cause hinge lock 90 to automatically (e.g., via gravity) reach a locked condition when vehicle 30 is in an unfolded operational configuration; 2) permit first frame portion 58 and second frame portion 60 to pivot to a limited degree about hinge 62 when hinge lock 90 is in a locked configuration; and/or 3) cause hinge lock 90 to move to an unlocked configuration when a user exerts and unfolding force on hinge lock 90 (e.g., by lifting hinge lock handle to fold vehicle 30) such as when a user moves vehicle 30 from an unfolded configuration to a folded configuration. In some embodiments, a user would merely lift on hinge handle 91 to transition hinge lock 90 to an unlocked configuration.

Hinge lock handle 91 may be rotated relative to receiver 92 to move catch 94 to engage or disengage from fastener 96. First frame portion 58 may include a recess 98 to receive hinge lock handle 91. First frame portion 58 may include an upper surface or deck 100. Recess 98 may be sized and dimensioned such that hinge lock handle 91 is below deck 100 when catch 94 is engaged with fastener 96. Hinge lock handle 91 may extend above deck 100 when catch 94 is disengaged from fastener 96. A handle that extends above deck 100 may make it easier for a user to grasp and lift second portion relative to first frame portion 58. Tiller 38 may be at least partially positioned within recess 98 when vehicle 30 is in the folded configuration.

While a user may grasp hinge lock handle 91 to move vehicle 30 to the folded configuration, it may be desirable for a user to fold vehicle 30 without the need to bend down to grasp handle. In some embodiments, a user may utilize tiller 38 to move vehicle 30 between the unfolded and folded configurations.

Referring to FIGS. 1 and 11, tiller 38 may be coupled to first frame portion 58. A yoke 102 (FIG. 11) may be coupled to each of first frame portion 58 and tiller 38. Tiller 38 may rotate relative to Yoke 102. Yoke 102 may include a hub 104 to receive a portion of tiller 38. Hub 104 may include a bushing or bearing such that tiller 38 is rotatably received in hub 104. Hub 104 may be a hollow structural member (e.g., cylinder, square, or tube stock).

A wheel fork 108 may be coupled to front wheel 34. Wheel fork 108 may extend from a lower end of hub 104. Tiller 38 may extend from an upper end of hub 104. At least a portion of one or both of tiller 38 and wheel fork 108 may extend through hub 104 such that tiller 38 is coupled to wheel fork 108. Tiller 38 may be rotationally fixed relative to wheel fork 108.

Yoke 102 may include legs 106 extending from hub 104. Each leg 106 may include a first portion (e.g., horizontal portion) and a second portion (e.g., vertical portion). Leg 106 may include an arcuate transition between first portion and second portion.

Referring to FIG. 11, it may be desirable for tiller 38 to rotate about axis A₄ relative to first frame portion 58 to allow a user to adjust an orientation of the tiller during use and/or to use the tiller as a lever to move the vehicle 30 between folded and unfolded configurations. In some embodiments, axis A₄ and axis A₁ are parallel but offset from each other (e.g., axis A₄ may be higher than axis A₁). In other embodiments, axis A₄ and axis A₁ are coaxial. A bearing 107 may couple at least one leg 106 to first frame portion 58. Bearing 107 may be fixed to first frame portion 58 while allowing leg 106 to rotate relative to first frame portion 58.

At least one leg 106 may include a tiller clutch 110. Clutch 110 may at least temporarily fix the position of yoke 102 relative to first frame portion 58 in a selected one of a plurality of positions. Clutch 110 may be coupled to each of first frame portion 58 and yoke 102. Clutch 110 may include a disk 112 fixed to first frame portion 58 (e.g., via adhesive weld, or fastener). In some embodiments, disk 112 and first frame portion 58 are a unitary construct. Disk 112 may include one or more recesses or openings 114. In some embodiments, openings 114 extend through disk 112. In other embodiments, openings 114 extend partially, but not completely, through disk 112. In some embodiments, openings 114 may be symmetrically spaced about a center point (e.g., axis A₄) of disk 112. In other embodiments, openings 114 are asymmetrically spaced about the center point.

Clutch 110 may include a shoe 116 adapted to engage disk 112 to fix the yoke 102 relative to first frame portion 58. Shoe 116 may selectively engage disk 112 in a plurality of positions. Shoe 116 may be rotationally fixed relative to leg 106 such that shoe 116 rotates with tiller 38.

Shoe 116 may include one or more cleats 118 protruding from a surface of shoe 116. Cleat 118 may be sized and shaped to fit within opening 114. Shoe 116 may be translate axially (e.g., along axis A₄) to move cleats 118 into and out of opening 114. Shoe 116 may be rotatable relative to disk 112. Shoe 116 may be translatable and rotatable relative to disk 112. Cleats 118 may be configured to engage in substantially all potential relative rotations of tiller 38 between the fully folded and fully unfolded configuration.

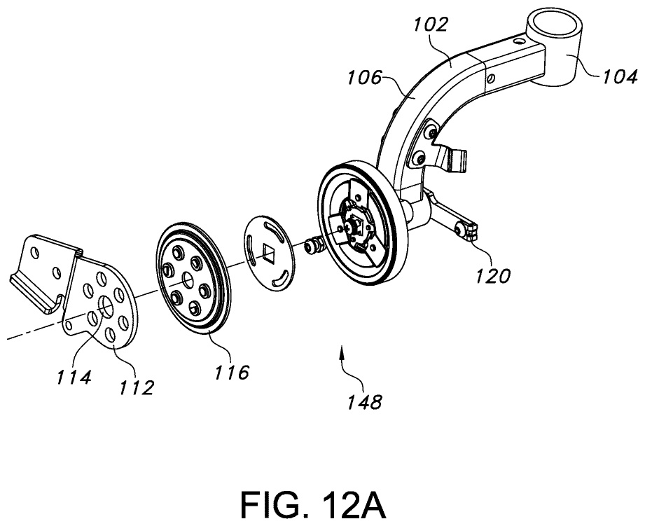

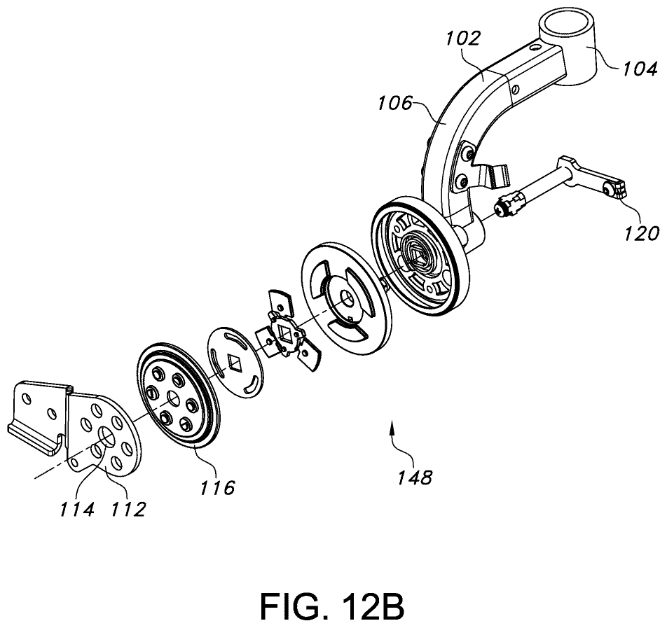

Referring to FIG. 12, clutch 110 may include a clutch lever 150 to selectively move shoe 116 into and out of engagement with disk 112. Clutch lever 150 may be movably (e.g., rotatable or slidable) coupled to a handhold 154. Clutch lever 150 may be coupled to handhold 154 by an axle, dowel, rod, or fastener such that clutch lever 150 is rotatable relative to handhold 154. In one embodiment, clutch lever 150 and handhold 154 are configured to cooperate such that when a user squeezes clutch lever 150 toward handhold 154, movement of clutch connector 152 causes clutch 148 to disengage in which condition tiller 38 is pivotable relative to frame 32.

Handhold 154 may be fixed to tiller 138 (e.g., via adhesive, weld, or fastener). Handhold 154 may be positioned such that tiller 38 is between the user and handhold 154 while vehicle 30 is being operated to prevent unintended contact between user and handhold 154 or clutch lever 150. Handhold 154 may include an outer wall defining an interior opening. Clutch lever 150 may be positioned within interior opening. Handhold 154 and clutch lever 150 may be sized and dimensioned such that a user can grasp handhold 154 and simultaneously move clutch lever 150 with one hand.

A lock may be operatively connected to clutch lever 150. The lock may be adapted to selectively prevent movement of clutch lever 150 when the lock is in a locked state and allow movement of clutch lever 150 when the lock is in an unlocked state. The lock may include a latch moveable into and out of the path of clutch lever 150 to lock and unlock respectively.

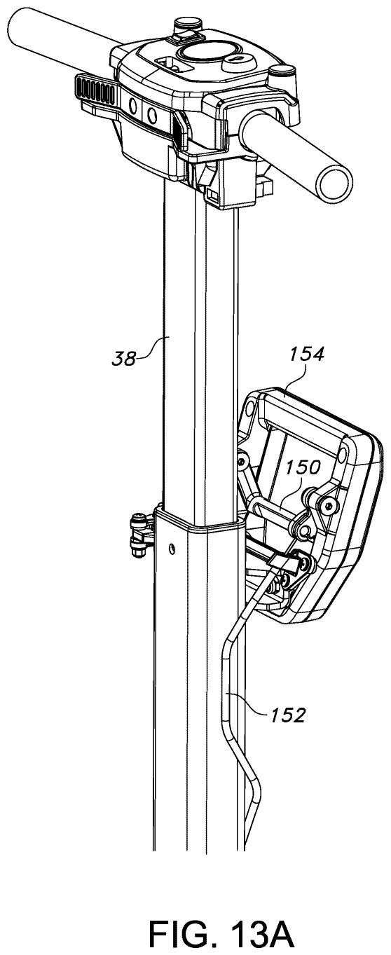

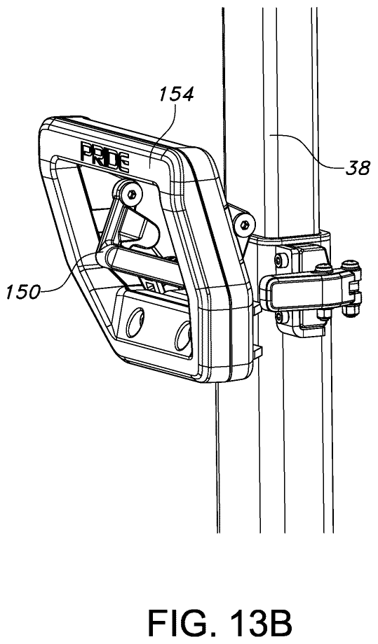

Clutch lever 150 (FIG. 13a and FIG. 13b) may be coupled to a connector 152 (e.g., cable, sheathed cable, chain, rope, or rod). Connector 152 may also be coupled to lever 120. Connector 152 may be a sheathed cable such that movement (e.g., rotation or sliding) of clutch lever 150 pulls connector 152, thereby transferring motion to lever 120. Movement of lever 120 may cause disengagement of shoe 116 from disk 112, thereby allowing tiller 38 to rotate relative to first frame portion 58. In some embodiments, clutch lever 150 is biased to a first position wherein shoe 116 is engaged with disk 112. Clutch lever 150 may be moved to a second position wherein shoe 116 is disengaged from disk 112 to allow tiller 38 to move relative to first frame portion 58.

A method to transition vehicle 30 from the unfolded configuration to the folded configuration may include actuating clutch lever 150 to disengage shoe 116 from disk 112 while shoe 116 is in a first orientation relative to disk 112.

Tiller 38 may be rotated in a first direction D₁ about axis A₄ (FIG. 11) to move tiller 38 toward recess 98 when shoe 116 is disengaged from disk 112. For example, a user may engage handhold 154 to rotate tiller 38. Clutch lever 150 may be released to allow shoe 116 to reengage disk 112 in a second orientation different from the first orientation. The step of actuating clutch lever 150 and rotating tiller 38 may be performed with one hand. The step of actuating clutch lever 150 and rotating tiller 38 may be performed without removing the hand from handhold 154.

Tiller 38 may then be rotated in a second direction D₂ about axis A₄. Tiller 38 and first frame portion 58 may rotate simultaneously as tiller 38 rotates about axis A₄. An end of first frame portion 58 which includes knuckle plate 64 may be raised vertically away from a ground surface as the first frame portion 58 rotates about axis A₄.

A user may repeat steps of disengaging shoe 116 from disk 112, rotating tiller 38 in first direction D₁, reengaging shoe 116 with disk 112, then rotating tiller 38 and first frame portion 58 in second direction D₂ until vehicle 30 is in the folded configuration. In some embodiments, a brake is applied to front wheel 34 and rear wheel 36 when shoe 116 is disengaged from disk 112 to prevent unintended movement of vehicle 30 when folding. First frame portion 58 may be detached from second frame portion 60 when vehicle is in the folded configuration as previously described. Tiller 38 may also be used to move vehicle 30 from the folded configuration to the unfolded configuration by engaging and disengaging shoe 116 and disk 112 and rotating tiller 38 and first frame portion 58 about axis A₄.

In one embodiment, there is a method of folding and unfolding a vehicle 30. In one embodiment, the method of folding vehicle 30 begins with vehicle 30 in an operative/driving unfolded configuration. A first step to folding vehicle 30 might include locking front wheel 34 by engage the front wheel lock 35 (FIG. 1). It will be appreciated that locking front wheel 34 may be useful at any point prior to initiating the pivot of first frame portion 58 relative to second frame portion 60. A user may then proceed to folding backrest 42 to a generally parallel position with seat base 41. In one embodiment, a user pulls a lock pin or otherwise disengages backrest lock 47 to enable folding of backrest 42.

After folding backrest 42, a user may then release seat 40 by slightly raising seat 40 and then (or simultaneously with raising) engage seat release 200. Once released, seat 40 is set down proximate deck 100.

The user may then engage the clutch lever 150 to put tiller 38 into a freely-pivoting configuration. While squeezing the clutch lever 150 with handhold 154 in one hand, a user may then pull up on hinge lock handle 91 thereby pivoting hinge lock handle 91 away from a position where it may engage fastener 96 (FIG. 10) in a manner that would inhibit folding. While lifting hinge lock handle 91 and vehicle 30 begins to fold, a user may steady first frame portion 58 and allow second frame 60 to fold against first frame portion 58 until vehicle 30 is folded and tiller 38 is in close proximity to deck 100. The user may then release clutch lever 150 thereby fixing the position of tiller 38 relative to first frame portion 58. A user may then rock vehicle 30 toward second frame portion 60 using tiller 38 until stand 49 engages the ground surface and folded vehicle 30 is free-standing.

From the freestanding position, the user may lock first frame portion 58 to second frame portion 60 by engaging locks 164 (which may be on one or two lateral sides of vehicle 30). Once locked, the user may tow the secured and folded vehicle 30 using tiller 38, for example. For stowing, tiller lock 56 may be disengaged to reduce the length of telescoping tiller 38 to a fully stowed configuration. Should a user choose to separate first frame portion 58 and second frame portion 60 at this stage, the user may operate lock(s) 164 and 80 to the released and open position and lift first frame portion 58 off second frame portion 60 using, for example, tiller 38, handles 50 and/or handhold 154. To reattached first frame portion 58 to second frame portion 60, the procedures is followed in reverse. When second frame portion 60 an upright free-standing position, first frame portion 58 may be moved into a connection position with second frame portion 60. In one embodiment, front wheel 34 is brought into contact with second frame portion 60 and using that contact position as flexible pivot point, a user may tile front frame portion 58 until keyway 70 is approximately aligned with hub bolt 74. The user may then allow the weight of front frame portion 58 to cause front frame portion 58 to seat into alignment with second frame portion 60 as hub bolt 74 passes through keyway 70 and moves into cooperative alignment with race 65.

To unfold vehicle 30 a user may follow the foregoing steps in reverse. Either before or after release the locks 164, a user may rock vehicle 30 forward until front wheel 34 engage the ground surface. In one embodiment, the configuration of front wheel 34 in the folded configuration allows front wheel 34 to engage the ground surface in this position. In one embodiment, a user may engage clutch lever 150 to position tiller 38 into a freely-pivoting position. While holding clutch lever 150, the user may grasp hinge lock handle 91 and begin to role second frame portion 60 away from first frame portion 58 and allowing vehicle 30 to fully unfold. Once first frame portion 58 and second frame portion 60 are in a generally co-planar configuration, the user may then release hinge lock handle 91 which freely pivots and drops into a position in which it would engage fastener 96 if first frame portion 58 and second frame portion 60 where to rotate to degree of rotation R. It should be noted that even if a user fails to reorient lever 82, first frame portion 58 and second frame portion 60 are prevented from being unlocked while vehicle 30 is in an unfolded operational mode.

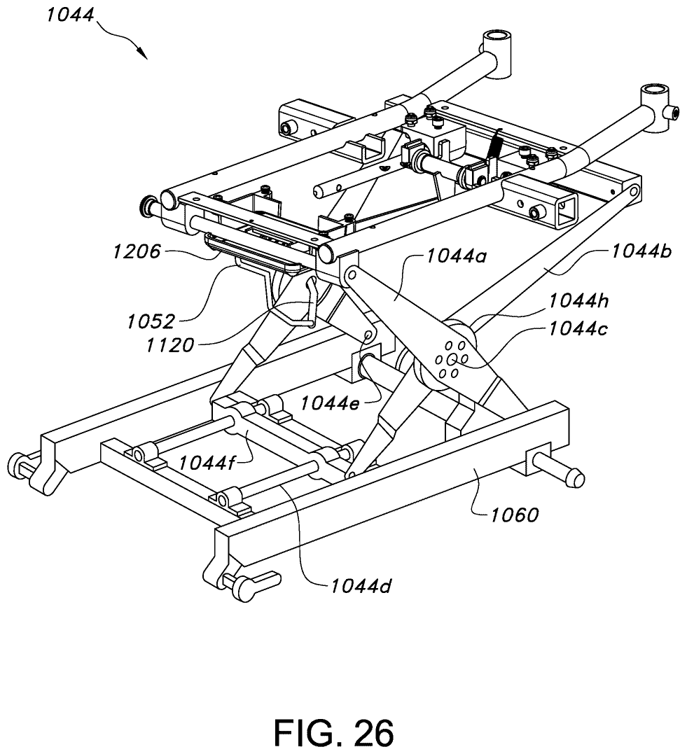

In another embodiment, vehicle 30 includes a lift 1044 as illustrated in FIG. 26. The lift 1044 may include a pivot lock 1044h coupled to the lift 1044 at a lift pivot 1044c. The pivot lock 1044h may perform substantially similar function to the tiller clutch 110, as described in more detail above. Pivot lock 1044h may be adapted to prevent movement of lift supports 1044a, 1044b relative to each other when pivot lock 1044h is in a locked state and allow movement of lift supports 1044a, 1044b relative to each other when pivot lock 1044h is in an unlocked state. A release grip 1206 may be coupled to a lever 1120 by a connector 1052 (e.g., cable, sheathed cable, chain, rope, or rod). Connector 1052 may include a sheathed cable including a sheath and a cable, the cable being moveable relative to the sheath. The connector 1052 may be configured to act on lever 1120 such that movement (e.g., rotation or sliding) of release grip 1206 pulls connector 1052, thereby transferring motion to lever 1120. Movement of lever 1120 may move the pivot lock 1044h into the unlocked state, thereby allowing lift 1044 to translate seat 40 up or down relative to a second frame portion 1060.

The pivot lock 1044h may be disposed between lift supports 1044a, 1044b at the lift pivot 1044c. In one embodiment, the pivot lock 1044h is disposed on a right side of lift supports 1044a, 1044b at the lift pivot 1044c or on a left side of lift supports 1044a, 1044b at the lift pivot 1044c. In one embodiment, more than one pivot lock 1044h may be coupled to the lift 1044. The pivot lock 1044h may include a connector 1052 extending between the pivot lock 1044h to the release grip 1206. The pivot lock 1044h may be moved to the unlocked configuration by the connector 1052 as an upward force is applied to the release grip 1206. Lift 1044 and pivot lock 1044h may be configured to cooperate such that the engagement of the release grip 1206 and movement of seat 40 causes lift supports 1044a, 1044b to freely pivot about lift pivot 1044c in a freely pivoting configuration. From this freely pivoting configuration, the user may adjust the seat height. Pivot lock 1044h may include an internal biasing element configured to bias the pivot lock 1044h such that removal of an upward force applied to the release grip 1206 urges the connector 1052 toward the pivot lock 1044h such that pivot lock 1044h may restrict movement of the lift supports 1044a, 1044b relative to each other. Lift supports 1044a, 1044b may include one or more apertures extending therethrough configured to receive a lock extension of the pivot lock 1044h when there is no upward force applied to the release grip 1206.

As illustrated in FIG. 26, a first end of lift support 1044a may be fixed to second frame portion 1060 at a fixed pivot point 1044e that allows lift support 1044a to pivot about fixed pivot point 1044e and prevents lift support 1044a from side-to-side or front-to-back movement. The opposing end of lift support 1044a may be pivotably coupled to seat 40. Vehicle 30 may be equipped with one or more slide rails 1044d. Slide rails 1044d, may be secured to one or more lift supports 1044a, 1044b. Lift support 1044b may be coupled to slide rail 1044d in a configuration that permits lift support 1044b to slide along slide rail 1044d as lift support 1044b pivots relative to slide rail 1044d. Slide rail 1044d and lift support 1044b may cooperate to prevent lift support 1044b from side-to-side movement (e.g., transverse to the sliding direction along a longitudinal axis of slide rail 1044d). In some embodiments, lift support 1044a includes (or is coupled to) a sliding stabilizer 1044f which is coupled to and is oriented transverse to slide rails 1044d.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

1-56. (canceled)

57. A vehicle comprising:
a frame having:
a first portion coupled to a front wheel and coupled to a tiller, and
a second portion coupled to a rear wheel and coupled to the first portion;
a hinge coupled to each of the first portion and the second portion such that the first portion is rotatable relative to the second portion about the hinge to transition the vehicle between a folded configuration and an unfolded configuration; and
a tiller pivotably coupled to the first portion over a pivot range, the tiller including a tiller clutch engageable to selectively fix the tiller relative to the first portion at a plurality of locations in the pivot range when the vehicle is in at least one of the folded configuration and the unfolded configuration.

58. The vehicle of claim 57, wherein the tiller clutch includes:
a disk fixed to one of the tiller and the first portion;
a shoe coupled to the other of the tiller and the first portion, the shoe configured to engage the disk;
an actuator configured to selectively move the shoe into and out of engagement with the disk; and
a caliper configured to move the shoe relative to the disk.

59. The vehicle of claim 58, wherein the vehicle is configured to at least partially transition from the unfolded configuration to the folded configuration when a force is applied to the tiller.

60. The vehicle of claim 59, wherein the force applied to the tiller is configured to cause the first portion of the frame to rotate about a rotation axis such that an end of the first portion coupled to the hinge is raised relative to a ground surface.

61. The vehicle of claim 59, wherein the actuator is disposed at least partially within a handhold of the tiller clutch,
wherein the handhold is positioned on the tiller such that a user can actuate the actuator and apply the force to the tiller without releasing the handhold, and
wherein the actuator is positioned on the tiller such that a user can simultaneously actuate the actuator and apply the force to the tiller without releasing the handhold.

62. The vehicle of claim 57, wherein the first portion has a first portion longitudinal axis and the second portion has a second portion longitudinal axis, and
wherein vehicle is configured such that the first portion longitudinal axis that second portion longitudinal axis are i) substantially coaxial in an unfolded configuration; and ii) substantially parallel in a folded configuration.

63. The vehicle of claim 62, wherein the vehicle includes a vehicle longitudinal axis extending from a front of the vehicle to a rear of the vehicle,
wherein the first portion longitudinal axis and the second portion longitudinal axis are substantially parallel to the vehicle longitudinal axis when the vehicle is in an unfolded configuration, and
wherein the first portion longitudinal axis and the second portion longitudinal axis are laid off relative to a plane perpendicular to a ground surface when the vehicle is in a folded free-standing configuration.

64. The vehicle of claim 57, wherein the vehicle includes an unfolded operational cross sectional rectangular area and fully folded cross sectional rectangular area that is approximately ⅓ a size of the unfolded operational cross sectional rectangular area.

65. The vehicle of claim 57, wherein the vehicle includes an unfolded operational cross sectional rectangular area and fully folded cross sectional rectangular area that is approximately ⅓ to ¼ a size of the unfolded operational cross sectional rectangular area.

66. The vehicle of claim 57, wherein the tiller includes a tiller actuator configured to transition the tiller clutch between an engaged configuration at which the tiller is prevented from pivoting relative to the first portion and a disengaged configuration at which the tiller is not prevented from pivoting relative to the first portion.

67. The vehicle of claim 57, wherein the first portion is configured to pivotably lock to the second portion when the vehicle is transitioned from the unfolded configuration to the folded configuration.

68. The vehicle of claim 57, wherein the tiller is pivotable relative to the first portion as the vehicle is transitioned between the folded configuration and the unfolded configuration.

69. The vehicle of claim 57, wherein the tiller is rotationally fixed relative to the first portion as the vehicle is transitioned between the folded configuration and the unfolded configuration.

70. The vehicle of claim 57, wherein the tiller includes a first tiller portion and a second tiller portion telescopically nested with the first tiller portion.

71. The vehicle of claim 57, wherein the second portion is detachably coupled to the first portion.

72. A vehicle comprising:
a frame including:
a first portion coupled to a front wheel and coupled to a tiller;
a second portion coupled to a rear wheel and coupled to the first portion via a hinge having a knuckle engageable with a hub bolt to secure the first portion to the second portion,
wherein the vehicle is transitionable about the hinge between a folded configuration and an unfolded configuration in which the first portion is lockable to the second portion.

73. The vehicle of claim 72, wherein the knuckle is fixed to one of the first portion or the second portion and the hub bolt is fixed to the other of the first portion and the second portion.

74. The vehicle of claim 73, further comprising:
a lock having a manual actuator selectable to an unlocked state and a locked state,
wherein the vehicle automatically transitions the actuator from the unlocked state to the locked state in response to the vehicle transitioning to an unfolded configuration.

75. The vehicle of claim 74, wherein the manual actuator is selectable to the locked state when the vehicle is in the folded configuration and when the vehicle is in the unfolded configuration.

76. The vehicle of claim 72, wherein the knuckle defines a receiving area to receive the hub bolt to couple the first portion to the second portion.

77. The vehicle of claim 76, wherein the knuckle and the lock cooperate to prevent the hub bolt from entering or exiting the knuckle when the lock is in a locked position.

78. The vehicle of claim 72, wherein the hub bolt has a longitudinal axis, a first cross-section width at a selected point along the longitudinal axis and a second cross-section width at the selected point along the longitudinal axis, the second cross-section width being larger than the first cross-section width.

79. The vehicle of claim 78, wherein the hinge includes a leaf and an open keyway between the knuckle and the leaf, the open keyway having an open keyway dimension larger than the first cross-section width of the hub bolt and smaller than the second cross-section width of the hub bolt such that the hub bolt is moveable into and out of the knuckle when the first portion of the hub bolt is aligned to pass through the open keyway and the knuckle prevents the hub bolt from entering or leaving a receiving area when the second portion of the hub bolt is aligned to pass through the open keyway.

80. The vehicle of claim 79, further comprising:
a lock including a lever configured to rotate the hub bolt relative to the knuckle such that the open keyway is configured to receive the first portion of the hub bolt when the lock is in an unlocked state and the open keyway is prevented from receiving the second portion of the hub bolt when the lock is in a locked state.

81. The vehicle of claim 80, wherein the lever is manually rotatable.

82. The vehicle of claim 80, wherein the lock includes a projection configured to engage a portion of the lever to automatically rotate the hub bolt relative to the knuckle as the vehicle moves from a folded configuration to an unfolded configuration.

83. The vehicle of claim 80, wherein the hub bolt is rotationally fixed relative to the lever and is rotatably coupled to the one of the first portion and the second portion of the frame.

84. The vehicle of claim 80, wherein the first portion is rotatable relative to the second portion when the lock is in the locked state.

85. The vehicle of claim 72, wherein the first portion is rotatable relative to the second portion about the hub bolt.

86. The vehicle of claim 72, wherein the first portion has a first portion longitudinal axis and the second portion has a second portion longitudinal axis, and
wherein the hub bolt is detachable from the knuckle when the first portion and the second portion are pivoted about the hinge such that the first portion longitudinal axis and the second portion longitudinal axis form an acute angle therebetween.

87. The vehicle of claim 86, wherein the second portion is detachably coupled to the first portion, and wherein the second portion is detachable from the first portion when the vehicle is in a folded configuration.

88. The vehicle of claim 86, wherein hub bolt is detachable from the knuckle when the first portion longitudinal axis and the second portion longitudinal axis form an acute angle of at least at least about 5 degrees, at least about 10 degrees, at least about 5 degrees to about 10 degrees, or at least about 10 degrees to about 15 degrees.

89. A method of transitioning a vehicle between a folded configuration and an unfolded configuration, the vehicle including a frame having a first portion coupled to a front wheel and pivotably coupled to a tiller, a second portion coupled to a rear wheel and coupled to the first portion comprising:
rotating the first portion relative to the second portion between the folded configuration and unfolded configuration to cause the first portion of the frame to lock to the second portion of the frame.

90. The method of claim 89, wherein the tiller includes a tiller clutch configured to selectively fix the tiller relative to the first portion, the method further comprising:
disengaging the tiller clutch such that the tiller is movable relative to the first portion;
pivoting the tiller relative to the first portion; and
reengaging the tiller clutch such that the tiller is rotationally fixed relative to the first portion.

91. The method of claim 90, further comprising:
transitioning the vehicle from the unfolded configuration toward the folded configuration by rotating the tiller relative to a ground surface while the tiller clutch is engaged such that the first portion of the frame rotates about a frame rotation axis thereby causing an end of the first portion to be raised vertically.

92. The method of claim 90, further comprising:
transitioning the vehicle from the unfolded configuration toward the folded configuration by simultaneously disengaging the tiller clutch and lifting, relative to a ground surface, a handle coupled to the second portion while the tiller clutch is disengaged such that the first portion pivots about the front wheel thereby causing an end of the first portion to be raised vertically.

93. The method of claim 90, wherein the tiller includes a handhold and the method includes engaging the handhold with a user's hand, and
wherein disengaging the tiller clutch and pivoting the tiller are both performed without removing the user's hand from the handhold.

94. The method of claim 89, wherein the second portion is detachably coupled to the first portion, and wherein the vehicle includes a lock moveable from an unlocked state to a locked state, and wherein rotating the first portion relative to the second portion causes one of the first portion and the second portion to move the lock from the unlocked state to the locked state.

95. The method of claim 94, wherein one of the first portion and the second portion moves the lock from the unlocked state to the locked state.

96. The method of claim 94, wherein the lock is manually moveable from the unlocked state to the locked state when the vehicle is in the folded configuration.

97. The method of claim 94, wherein transitioning the lock from the unlocked state to the locked state includes rotating a portion of the lock relative to at least one of the first portion and the second portion.

98. The method of claim 94 further comprising:
transitioning the vehicle from the unfolded configuration to the folded configuration; moving the lock from the locked state to the unlocked state; and detaching the first portion from the second portion.

99. The method of claim 98, wherein in the unlocked state, the first portion is not detachable from second portion if the first portion of the frame and the second portion of the frame are hinged to form an acute angle of at least about 5 degrees, at least about 10 degrees, at least about 5 degrees to about 10 degrees, or at least about 10 degrees to about 15 degrees.

100. The method of claim 98, wherein the lock comprises a lever and moving the lock from the locked state to the unlocked state includes manually pivoting the lever relative to at least one of the first portion and the second portion.
